(19) United States
(12) Patent Application Publication
(10) Pub. No.: US 2025/0212110 A1
(43) Pub. Date: Jun. 26, 2025

(54) CELL SELECTION OF A PASSIVE DEVICE

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US); Junyi LI, Greentown, PA (US)

(21) Appl. No.: 18/852,323

(22) PCT Filed: Jun. 10, 2022
(86) PCT No.: PCT/CN2022/098069

§ 371 Date: Sep. 27, 2024

(51) Int. Cl. H04W 48/20; H04L 5/00; H04W 48/08

(52) U.S. Cl. CPC H04W 48/20; H04L 5/0048; H04W 48/08

(57) ABSTRACT

Methods, systems, and devices for wireless communication are described. In some cases, an energy receiver (e.g., a passive radio frequency identifier (RFID) device) may receive one or more messages from one or more energy transmitters (e.g., network entities), each message identifying a cell associated with an energy transmitter and additional corresponding cell information, and indicating one or more resources on which the energy receiver may receive a reference signal for cell selection from the energy transmitter. The energy receiver may receive the reference signal and perform a measurement on the reference signal. In some cases, the energy receiver may select a cell based on the reference signal (e.g., the measurement) and the energy transmitter supporting energy harvesting. The energy receiver may transmit a second message that indicates the selected cell associated with the energy transmitter.

### CROSS REFERENCE

The present Application is a 371 national stage filing of International PCT Application No. PCT/CN2022/098069 by YANG et al. entitled “CELL SELECTION OF A PASSIVE DEVICE,” filed Jun. 10, 2022, which is assigned to the assignee hereof, and which is expressly incorporated by reference in its entirety herein.

### TECHNICAL FIELD

The following relates to wireless communication, including cell selection of a passive device.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support communications between an energy transmitter device and an energy receiver device. The energy receiver device may harvest energy from an energy signal transmitted by the energy transmitter device in order to communicate signals with the energy transmitter device. In some cases, however, the energy receiver device may communicate inefficiently with cells of energy transmitter devices.

### SUMMARY

The described techniques relate to improved methods, systems, devices, and apparatuses that support cell selection of a passive device. For example, the described techniques provide for cell selection by an energy receiver device (e.g., a passive radio frequency identifier (RFID) device, a user equipment (UE)). In some examples, an energy receiver device may select a cell for communications with an energy transmitter device (e.g., a network entity) based on cell information and reference signals transmitted by the energy transmitter device. For example, one or more energy transmitter devices may transmit one or more first messages identifying cell information such as a cell associated with one of the energy transmitter devices, and indicating one or more resources on which the energy receiver device may receive a reference signal for cell selection. In addition, the one or more messages may indicate whether the energy transmitter device supports energy harvesting, among other cell information. After receiving the cell information and one or more reference signals from one or more energy transmitter devices, the energy receiver device may backscatter the cell information to the energy transmitter device. For example, based on a measurement of the one or more reference signals (e.g., reference signal received power (RSRP) measurements), the energy receiver device may select a cell and indicate (e.g., via backscattering, transmission) the selection back to the corresponding energy transmitter device.

A method for wireless communication at an energy receiver device is described. The method may include receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection, receiving, from the one or more energy transmitter devices, the reference signal on the one or more resources, and transmitting a second message that indicates a cell associated with one of the one or more energy transmitter devices, the cell selected by the energy receiver device based on the reference signal and the one of the one or more energy transmitter devices supporting energy harvesting.

An apparatus for wireless communication at an energy receiver device is described. The apparatus may include at least one processor, and memory coupled with the at least one processor, the memory storing instructions executable by the at least one processor to cause the energy receiver device to receive one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection, receive, from the one or more energy transmitter devices, the reference signal on the one or more resources, and transmit a second message that indicates a cell associated with one of the one or more energy transmitter devices, the cell selected by the energy receiver device based on the reference signal and the one of the one or more energy transmitter devices supporting energy harvesting.

Another apparatus for wireless communication at an energy receiver device is described. The apparatus may include means for receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection, means for receiving, from the one or more energy transmitter devices, the reference signal on the one or more resources, and means for transmitting a second message that indicates a cell associated with one of the one or more energy transmitter devices, the cell selected by the energy receiver device based on the reference signal and the one of the one or more energy transmitter devices supporting energy harvesting.

A non-transitory computer-readable medium storing code for wireless communication at an energy receiver device is described. The code may include instructions executable by at least one processor to receive one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection, receive, from the one or more energy transmitter devices, the reference signal on the one or more resources, and transmit a second message that indicates a cell associated with one of the one or more energy transmitter devices, the cell selected by the energy receiver device based on the reference signal and the one of the one or more energy transmitter devices supporting energy harvesting.

In some examples of the method, apparatuses, and non-transitory computer-readable medium described herein, receiving the one or more messages may include operations, features, means, or instructions for receiving the one or more messages from the respective one or more energy transmitter devices, each message of the one or more messages indicating whether the energy transmitter device supports energy harvesting.

Some examples of the method, apparatuses, and non-transitory computer-readable medium described herein may further include operations, features, means, or instructions for identifying the cell associated with the energy transmitter device based on an orthogonal sequence of the one or more messages, where each of the one or more energy transmitter devices may be associated with one of a set of orthogonal sequences that include the orthogonal sequence.

Some examples of the method, apparatuses, and non-transitory computer-readable medium described herein may further include operations, features, means, or instructions for identifying the cell associated with the energy transmitter device based on a resource associated with the one or more messages, where each of the one or more energy transmitter devices may be associated with one of a set of resources that include the resource, and the resource includes a frequency resource, a time resource, or a combination thereof.

Some examples of the method, apparatuses, and non-transitory computer-readable medium described herein may further include operations, features, means, or instructions for identifying a cell identifier for the cell based on a mapping between a set of cell identifiers and a corresponding set of resources used for the one or more messages, where the set of resources include frequency resources, time resources, or a combination thereof.

In some examples of the method, apparatuses, and non-transitory computer-readable medium described herein, receiving the one or more messages may include operations, features, means, or instructions for receiving the one or more messages from the respective one or more energy transmitter devices, each message of the one or more messages indicating at least one type of energy receiver device supported by the energy transmitter device transmitting the message.

In some examples of the method, apparatuses, and non-transitory computer-readable medium described herein, receiving the one or more messages may include operations, features, means, or instructions for receiving the one or more messages from the respective one or more energy transmitter devices, each message of the one or more messages indicating a configuration of the reference signal, the configuration indicating a periodicity of the reference signal, a quantity of reference signals to be transmitted by the energy transmitter device, or a combination thereof, receiving the reference signal on the one or more resources in accordance with the configuration, and selecting the cell based on the configuration and the periodicity of the reference signal.

In some examples of the method, apparatuses, and non-transitory computer-readable medium described herein, receiving the one or more messages may include operations, features, means, or instructions for receiving the one or more messages from the respective one or more energy transmitter devices, each message of the one or more messages indicating a maximum repetition associated with the second message.

Some examples of the method, apparatuses, and non-transitory computer-readable medium described herein may further include operations, features, means, or instructions for decoding the one or more messages received from the respective one or more energy transmitter devices and transmitting the second message based on successfully decoding the one or more messages.

Some examples of the method, apparatuses, and non-transitory computer-readable medium described herein may further include operations, features, means, or instructions for transmitting the second message based on a signal strength value of a measurement of the reference signal exceeding a threshold.

Some examples of the method, apparatuses, and non-transitory computer-readable medium described herein may further include operations, features, means, or instructions for performing a measurement procedure of a reference signal from a set of multiple cells that include the cell and transmitting the second message indicating the cell based on the indicated cell having a highest signal strength among the set of multiple cells.

Some examples of the method, apparatuses, and non-transitory computer-readable medium described herein may further include operations, features, means, or instructions for generating a metric for each cell associated with the one or more energy transmitter devices based on an average measured RSRP for one or more reference signals received in a time period, a highest measured RSRP of a reference signal in a time window, an average measured RSRP of one or more highest measured RSRPs for one or more reference signals, or an averaged measured RSRP of one or more RSRPs above a threshold for one or more reference signals and selecting the cell based on the metric.

In some examples of the method, apparatuses, and non-transitory computer-readable medium described herein, transmitting the second message may include operations, features, means, or instructions for transmitting the second message that indicates a physical cell identifier (PCI) associated with the cell selected by the energy receiver device, where each message of the one or more messages indicates a PCI.

A method for wireless communication at an energy transmitter device is described. The method may include transmitting one or more messages to an energy receiver device, each message of the one or more messages identifying a cell associated with the energy transmitter device of one or more energy transmitter devices and indicating one or more resources for reception of a reference signal by the energy receiver device for cell selection, transmitting, to the energy receiver device, the reference signal on the one or more resources, and receiving a second message that indicates a cell associated with one of the one or more energy transmitter devices, the cell selected by the energy receiver device based on the reference signal and the one of the one or more energy transmitter devices supporting energy harvesting.

An apparatus for wireless communication at an energy transmitter device is described. The apparatus may include at least one processor, and memory coupled with the at least one processor, the memory storing instructions executable by the at least one processor to cause the energy transmitter device to transmit one or more messages to an energy receiver device, each message of the one or more messages identifying a cell associated with the energy transmitter device of one or more energy transmitter devices and indicating one or more resources for reception of a reference signal by the energy receiver device for cell selection, transmit, to the energy receiver device, the reference signal on the one or more resources, and receive a second message that indicates a cell associated with one of the one or more energy transmitter devices, the cell selected by the energy receiver device based on the reference signal and the one of the one or more energy transmitter devices supporting energy harvesting.

Another apparatus for wireless communication at an energy transmitter device is described. The apparatus may include means for transmitting one or more messages to an energy receiver device, each message of the one or more messages identifying a cell associated with the energy transmitter device of one or more energy transmitter devices and indicating one or more resources for reception of a reference signal by the energy receiver device for cell selection, means for transmitting, to the energy receiver device, the reference signal on the one or more resources, and means for receiving a second message that indicates a cell associated with one of the one or more energy transmitter devices, the cell selected by the energy receiver device based on the reference signal and the one of the one or more energy transmitter devices supporting energy harvesting.

A non-transitory computer-readable medium storing code for wireless communication at an energy transmitter device is described. The code may include instructions executable by at least one processor to transmit one or more messages to an energy receiver device, each message of the one or more messages identifying a cell associated with the energy transmitter device of one or more energy transmitter devices and indicating one or more resources for reception of a reference signal by the energy receiver device for cell selection, transmit, to the energy receiver device, the reference signal on the one or more resources, and receive a second message that indicates a cell associated with one of the one or more energy transmitter devices, the cell selected by the energy receiver device based on the reference signal and the one of the one or more energy transmitter devices supporting energy harvesting.

In some examples of the method, apparatuses, and non-transitory computer-readable medium described herein, transmitting the one or more messages may include operations, features, means, or instructions for transmitting the one or more messages from respective one or more energy transmitter devices, each message of the one or more messages indicating whether the energy transmitter device supports energy harvesting.

In some examples of the method, apparatuses, and non-transitory computer-readable medium described herein, each of the one or more energy transmitter devices may be associated with one of a set of orthogonal sequences.

In some examples of the method, apparatuses, and non-transitory computer-readable medium described herein, each of the one or more energy transmitter devices may be associated with resources of a set of resources that include the one or more resources, and the one or more resources includes a frequency resource, a time resource, or a combination thereof.

In some examples of the method, apparatuses, and non-transitory computer-readable medium described herein, each message of the one or more messages identifies the cell based on a mapping between a set of cell identifiers and a corresponding set of resources used for the one or more messages, where the set of resources include frequency resources, time resources, or a combination thereof.

In some examples of the method, apparatuses, and non-transitory computer-readable medium described herein, transmitting the one or more messages may include operations, features, means, or instructions for transmitting the one or more messages from respective one or more energy transmitter devices, each message of the one or more messages indicating at least one type of energy receiver device supported by the energy transmitter device transmitting the message.

In some examples of the method, apparatuses, and non-transitory computer-readable medium described herein, transmitting the one or more messages may include operations, features, means, or instructions for transmitting the one or more messages from respective one or more energy transmitter devices, each message of the one or more messages indicating a configuration of the reference signal, the configuration indicating a periodicity of the reference signal, a quantity of reference signals to be transmitted by the energy transmitter device, or a combination thereof and transmitting the reference signal on the one or more resources in accordance with the configuration.

In some examples of the method, apparatuses, and non-transitory computer-readable medium described herein, transmitting the one or more messages may include operations, features, means, or instructions for transmitting the one or more messages from respective one or more energy transmitter devices, each message of the one or more messages indicating a maximum repetition associated with the second message.

In some examples of the method, apparatuses, and non-transitory computer-readable medium described herein, receiving the second message may include operations, features, means, or instructions for receiving the second message based on the energy receiver device successfully decoding the one or more messages.

In some examples of the method, apparatuses, and non-transitory computer-readable medium described herein, receiving the second message may include operations, features, means, or instructions for receiving the second message based on a signal strength value of a measurement of the reference signal exceeding a threshold.

In some examples of the method, apparatuses, and non-transitory computer-readable medium described herein, receiving the second message may include operations, features, means, or instructions for receiving the second message indicating the cell selected by the energy receiver device based on the cell having a highest signal strength among a set of multiple cells.

In some examples of the method, apparatuses, and non-transitory computer-readable medium described herein, receiving the second message may include operations, features, means, or instructions for receiving the second message that indicates a PCI associated with the cell selected by the energy receiver device, where each message of the one or more messages indicates a PCI.

### BRIEF DESCRIPTION OF THE DRAWINGS

FIGS. 1 through 3 illustrate examples of wireless communications systems that support cell selection of a passive device in accordance with one or more aspects of the present disclosure.

FIG. 4 illustrates an example of a timeline that supports cell selection of a passive device in accordance with one or more aspects of the present disclosure.

FIGS. 5 and 6 illustrate examples of process flows that support cell selection of a passive device in accordance with one or more aspects of the present disclosure.

FIGS. 7 and 8 show block diagrams of devices that support cell selection of a passive device in accordance with one or more aspects of the present disclosure.

FIG. 9 shows a block diagram of a communications manager that supports cell selection of a passive device in accordance with one or more aspects of the present disclosure.

FIG. 10 shows a diagram of a system including a device that supports cell selection of a passive device in accordance with one or more aspects of the present disclosure.

FIGS. 11 and 12 show block diagrams of devices that support cell selection of a passive device in accordance with one or more aspects of the present disclosure.

FIG. 13 shows a block diagram of a communications manager that supports cell selection of a passive device in accordance with one or more aspects of the present disclosure.

FIG. 14 shows a diagram of a system including a device that supports cell selection of a passive device in accordance with one or more aspects of the present disclosure.

FIGS. 15 through 20 show flowcharts illustrating methods that support cell selection of a passive device in accordance with one or more aspects of the present disclosure.

### DETAILED DESCRIPTION

Some wireless communications systems may support communications between energy transfer devices, such as between an energy transmitter device and an energy receiver device. An energy receiver device may be a low power or passive communication device, such as a radio frequency identifier (RFID) device, a passive Internet of Things (IoT) device, a user equipment (UE), or some other energy receiver device, that uses energy harvested from signals received at the communication device to power one or more components of the communication device and communicate with an energy transmitter device. An energy transmitter device may be a communication device, such as a network entity, a base station, an RFID reader, or some other energy transmitter device, that may transmit, to an energy receiver device, an energy signal that may be harvested by the energy receiver device to support the communication of other signals between the energy transmitter device and the energy receiver device.

In some examples, an energy receiver device (e.g., a passive device) may be under coverage of multiple cells. To gain access to an energy transmitter device, the energy receiver device may select a favored cell and backscatter related information to a corresponding energy transmitter device to establish communications with the energy transmitter device. However, these and other techniques used in the deployment of energy harvesting processes may be lacking in efficiency and effectiveness. For example, the energy receiver device may select a deficient cell, or may lack techniques for selecting a sufficient cell. In addition, the energy transmitter device may fail to provide information to assist the energy receiver device in cell selection, which may result in decreased energy harvesting and decreased quality of communications between the energy receiver device and the energy transmitter device.

The techniques described herein may support improved cell selection by an energy receiver device (e.g., a passive device). In some examples, an energy receiver device may select a cell for communications with an energy transmitter device (e.g., a network entity) based on cell information and reference signals transmitted by the energy transmitter device. For example, one or more energy transmitter devices may transmit one or more first messages identifying cell information such as a cell associated with one of the energy transmitter devices, and indicating one or more resources on which the energy receiver device may receive a reference signal for cell selection. In addition, the one or more messages may indicate whether the energy transmitter device supports energy harvesting, among other cell information. After receiving the cell information and one or more reference signals from one or more energy transmitter devices, the energy receiver device may backscatter the cell information to the energy transmitter device. For example, based on a measurement of the one or more reference signals (e.g., reference signal received power (RSRP) measurements), the energy receiver device may select a cell and indicate the selection back to the corresponding energy transmitter device.

The reference signal may be a dedicated reference signal for such purposes, may be an existing reference signal sequence or design on resources configured for measurement by the energy receiver device, or may be a use or re-use of an existing reference signal transmitted by the energy transmitting device (e.g., a demodulation reference signal (DMRS), channel state information reference signal (CSI-RS), synchronization signal block (SSB) (including one or more of a primary synchronization signal (PSS), secondary synchronization signal (SSS), DMRS of a physical broadcast channel (PBCH)).

Aspects of the subject matter described herein may be implemented to realize one or more of the following potential improvements, among others. The techniques employed by the described communication devices may enable cell selection of a passive device, which may support improved communications between an energy receiver device and an energy transmitter device. For example, by selecting a cell based on cell information and reference signals transmitted by one or more energy transmitter devices, an energy receiver device may improve energy harvesting techniques by establishing communications with an energy transmitter device that supports energy harvesting. In addition, the described cell selection operations may increase quality of communications between the energy receiver device and the energy transmitter device, among other benefits.

Aspects of the disclosure are initially described in the context of wireless communications systems. Aspects of the disclosure are then described in the context of timelines and process flows. Aspects of the disclosure are further illustrated by and described with reference to apparatus diagrams, system diagrams, and flowcharts that relate to cell selection of a passive device.

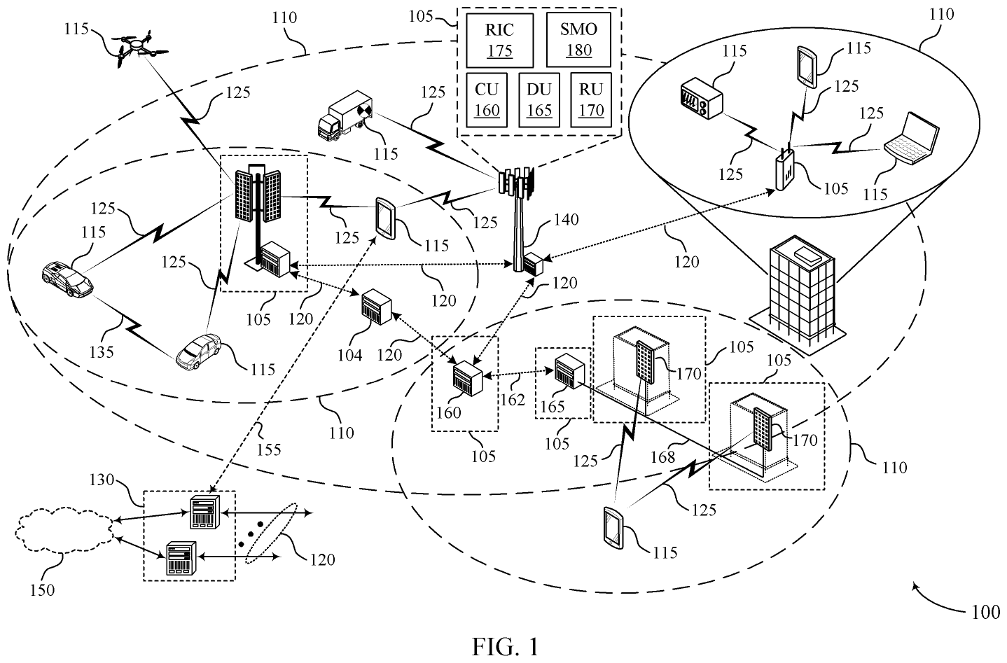

FIG. 1 illustrates an example of a wireless communications system 100 that supports cell selection of a passive device in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cell selection of a passive device as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCI), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The wireless communications system 100 may support wireless communications between energy transfer devices, such as wireless communications between an energy transmitter device and an energy receiver device. Examples of energy transmitter devices include a network entity 105, a base station 140, and an RFID reader, among other energy transmitter devices. That is, an energy transmitter device may be a communication device that may transmit, to an energy receiver device, an energy signal that may be harvested by an energy receiver device to support the communication of other signals (e.g., information signals) between the energy transmitter device and the energy receiver device. For example, the energy receiver device may harvest and use energy from the energy signal to power one or more components of the energy receiver device and communicate with the energy transmitter device (e.g., process received information signals, transmit information signals, backscatter information signals). Examples of energy receiver devices include an RFID tag, a wireless-powered IoT device (e.g., devices which may harvest energy, such as a passive device, a semi-passive device, an active tag), a wireless-powered IoE device, and a UE 115 (e.g., a low power or low complexity UE 115), among other energy receiver devices. That is, an energy receiver device may be a communication device that uses harvested energy (e.g., at least in part) from received energy signals to perform wireless communications.

In some examples, energy transmitting devices such as RFID systems may be utilized because of economic benefits in inventory and asset management inside and outside of a warehouse, IoT connectivity, sustainable sensor networks in factories and agriculture settings, and in smart homes, among other examples. In some examples, an RFID system may include small transponders (e.g., tags, RFID tags) which may emit (backscatter) information-bearing signals upon receiving a signal (e.g., from an energy transmitter device). Some RFID systems may operate without a battery at low operating expenses, a low maintenance cost, and a long life-cycle. In some cases, passive RFID devices may harvest energy over-the-air to power the transmission and reception circuitry, where signals may be backscatter modulated. Some RFID systems may include a reader and a tag, where the tag may be a passive, semi-passive, or active device. If the tag is a passive device, the energy receiver device may operate without a battery, low operating expenses, low maintenance costs, and a long life-cycle.

In some cases, to manage passive IoT devices, a network entity may read and write information stored on passive IoT devices, provide energy to the passive IoT devices (e.g., the network entity being an energy transmitter device, the passive IoT device being an energy receiver device), or both. In addition, a passive IoT device may reflect an information-bearing signal to the network entity, and the network entity may read the reflected signal to decode the information transmitted by the passive IoT device.

In accordance with examples disclosed herein, the wireless communications system 100 may support cell selection by an energy receiver device (e.g., a passive device). In some examples, an energy receiver device may select a cell for communications with an energy transmitter device (e.g., a network entity) based on cell information and reference signals transmitted by the energy transmitter device. For example, one or more energy transmitter devices may transmit one or more first messages identifying cell information such as a cell associated with one of the energy transmitter devices, and indicating one or more resources on which the energy receiver device may receive a reference signal for cell selection. In addition, the one or more messages may indicate whether the energy transmitter device supports energy harvesting, among other cell information. After receiving the cell information and one or more reference signals from one or more energy transmitter devices, the energy receiver device may backscatter the cell information to the energy transmitter device. For example, based on a measurement of the one or more reference signals (e.g., RSRP measurements), the energy receiver device may select a cell and indicate the selection back to the corresponding energy transmitter device.

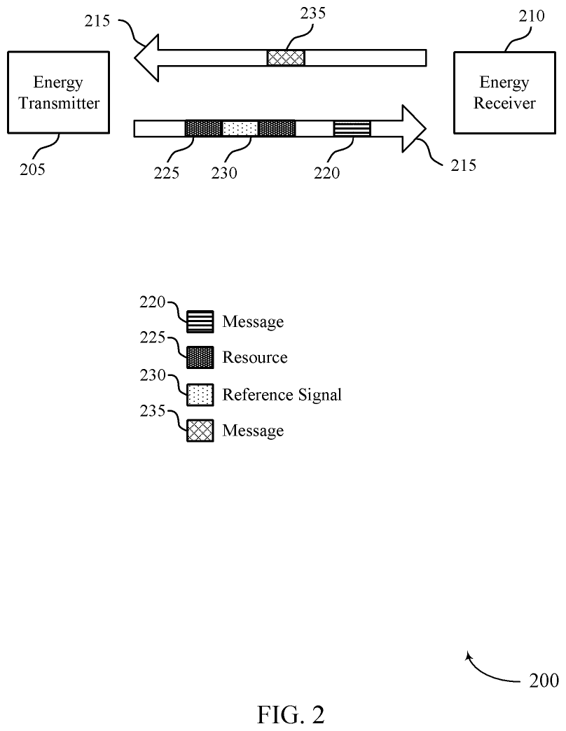

FIG. 2 illustrates an example of a wireless communications system 200 that supports cell selection of a passive device in accordance with one or more aspects of the present disclosure. The wireless communications system 200 may implement or be implemented by aspects of the wireless communications system 100 described with reference to FIG. 1. For example, the wireless communications system 200 may include an energy transmitter 205 and an energy receiver 210. In some examples, the energy transmitter 205 may be an example of an energy transmitter device or a network entity 105 described with reference to FIG. 1. In some examples, the energy receiver 210 may be an example of an energy receiver device or a UE 115 described with reference to FIG. 1. The wireless communications system 200 may support cell selection by the energy receiver 210 based on cell information transmitted from the energy transmitter 205, which may result in more efficient power harvesting and improved communications between the energy transmitter 205 and the energy receiver 210, among other benefits.

The wireless communications system 200 may support communications between the energy transmitter 205 and the energy receiver 210. For example, the energy transmitter 205 may communicate signals with the energy receiver 210 over respective communication links 215, which may be examples of a communication link 125 described with reference to FIG. 1. In some examples, the energy receiver 210 may communicate with multiple energy transmitters 205 via multiple respective communication links 215.

To support communications between the energy transmitter 205 and the energy receiver 210, the energy transmitter 205 may be configured to perform wireless power transfer to the energy receiver 210. In some examples, the energy transmitter 205 may transmit an energy signal to the energy receiver 210 via a channel (e.g., over a communication link 215), and the energy receiver 210 may perform energy harvesting to harvest energy from the energy signal for use in powering one or more components of the energy receiver 210. For example, the energy accumulated during an energy harvesting operation may be used to power an IC (e.g., or another chip) at the energy receiver 210, which may perform local computations (e.g., decoding).

As described herein, the energy receiver 210 may perform cell selection based on cell information and reference signals 230 received from one or more energy transmitters 205. For example, the energy receiver 210 may be under the coverage of multiple cells (e.g., corresponding to multiple energy transmitters 205). The energy receiver 210 may receive one or more messages 220 from respective energy transmitters 205, each message identifying a cell associated with an energy transmitter 205 and indicating one or more resources 225 on which the energy receiver 210 may receive a reference signal 230 for cell selection. The message 220 may be a message (e.g., a Select command message formatted according to an RFID protocol) formatted to include a cell identifier, other or additional cell information, or both. For example, the message 220 may identify the cell associated with the energy transmitter 205 using a PCI indicated in a field of the Select command. In addition, the message 220 may indicate whether the energy transmitter 205 supports energy harvesting (e.g., fully, temporally, or not at all). For example, if the energy transmitter 205 supports energy harvesting, the energy receiver 210 (e.g., a passive device) may select a corresponding cell and communicate with the energy transmitter 205 effectively as the energy receiver 210 may harvest sufficient energy from the energy transmitter 205. Alternatively, if the energy transmitter 205 lacks support for energy harvesting, the energy receiver 210 may refrain from selecting a corresponding cell as the energy receiver 210 may fail to harvest enough energy from the energy transmitter 205.

Additionally, the message 220 may indicate at least one type of energy receiver 210 supported by the energy transmitter 205 transmitting the message 220. For example, the energy transmitter 205 may indicate support for fully passive devices, semi-passive devices, or both. In some examples, the message 220 may indicate a reference signal configuration which the energy transmitter 205 may use to transmit a reference signal 230 to the energy receiver 210. The reference signal configuration may include a periodicity of reference signals 230 transmitted by the energy transmitter 205 (e.g., if the energy receiver 210 is a semi-passive device), a quantity of reference signals 230 to be transmitted by the energy transmitter 205, or a combination thereof. Additionally, or alternatively, the message 220 may indicate a maximum repetition of backscattering. That is, the energy transmitter 205 may configure a behavior of the energy receiver 210 regarding how many times (e.g., repetitions) the energy receiver 210 may backscatter cell information to the energy transmitter 205 during a cell selection operation.

One or more energy transmitters 205 may periodically broadcast the one or more messages 220 to the energy receiver 210 (e.g., in a system information block (SIB) or a master information block (MIB)). In some cases, one or more energy transmitters 205 broadcasting a waveform to the energy receiver 210 at a same time and a same frequency may broadcast a corresponding PCI such that the energy receiver 210 may distinguish each transmission from respective energy transmitters 205. For example, each PCI corresponding to respective energy transmitters 205 may be represented by different orthogonal sequences such that the energy receiver 210 may blind decode information in the message 220 based on the set of orthogonal PCIs to determine which PCI is being transmitted in the message 220. That is, the energy receiver 210 may identify the cell associated with the energy transmitter 205 based on an orthogonal sequence of the one or more messages 220, where each of the multiple energy transmitters 205 is associated with one of a set of orthogonal sequences including the orthogonal sequence.

Alternatively, different cell identifiers (e.g., PCIs) may be associated with different frequency resources, time resources, or a combination thereof that are FDMed or TDMed. For example, the energy receiver 210 may identify the cell associated with the energy transmitter 205 based on a resource 225 associated with the one or more messages 220, where each of the one or more energy transmitters 205 is associated with one of a set of resources that include the resource 225, the resource 225 being a frequency resource, a time resource, or a combination thereof.

In some cases, the energy receiver 210 may identify a cell identifier (e.g., a PCI) for the cell associated with the energy transmitter 205 based on a mapping between a set of cell identifiers (e.g., a set of PCIs) and a corresponding set of resources including the resource 225 used by the one or more energy transmitters 205 to transmit the one or more messages 220. The resources may include frequency resources, time resources, or a combination thereof. In some examples, the energy receiver 210 may determine the cell identifier based on the location of the waveform transmitted by an energy transmitter 205, where the energy transmitter 205 has a fixed location (e.g., in a static scenario). As the energy receiver 210 may lack timing information regarding when the energy transmitter 205 may transmit the one or more messages 220, the mapping may be between the set of cell identifiers and a corresponding set of frequency resources.

After receiving one or more messages 220 from one or more energy transmitters 205, the energy receiver 210 may receive a reference signal 230 from the energy transmitter 205 on one or more resources 225 (e.g., frequency resources, time resources, or a combination thereof). The energy receiver 210 may receive the reference signal 230 in accordance with the reference signal configuration, for example, with a particular periodicity. In some cases, the energy receiver 210 may select a cell and backscatter the cell information to the energy transmitter 205 based on performing a measurement on the reference signal 230. For example, the energy receiver 210 may select a cell based on the reference signal 230 and the energy transmitter 205 supporting energy harvesting. Accordingly, the energy receiver 210 may transmit a second message 235 to the energy transmitter 205, the second message 235 indicating the selected cell. As such, the energy receiver 210 may backscatter the cell information (e.g., a PCI of the selected cell) to the energy transmitter 205 in the second message 235.

In some cases, the energy receiver 210 may select the cell associated with the energy transmitter 205 based on the reference signal configuration and the periodicity of the reference signal 230 transmitted by the energy transmitter 205. Alternatively, the energy receiver 210 may decode the one or more messages 220 received from one or more respective energy transmitters 205, and the energy receiver 210 may transmit the second message 235 (e.g., backscatter the cell information) based on successfully decoding the one or more messages 220.

In some examples, the energy receiver 210 may measure a channel quality or a signal strength of the reference signal 230 (e.g., an RSRP, a reference signal strength indicator (RSSI), a reference signal received quality (RSRQ)), and backscatter the cell information based on the measurement. For example, the energy receiver 210 may transmit the second message 235 based on a signal strength value (e.g., a measured RSRP, RSSI, or RSRQ) of the reference signal 230 exceeding a threshold. That is, the energy receiver 210 may define a threshold for the measurement of the reference signal 230 and backscatter the cell information to the energy transmitter 205 when a measured value exceeds the threshold. Alternatively, the energy receiver 210 may define a threshold for a quantity of measured cells, and the energy receiver 210 may backscatter the cell information for a cell with the highest measured results. For example, the energy receiver 210 may perform a measurement procedure of a reference signal 230 from a set of cells that include the cell associated with the energy transmitter 205. The energy receiver 210 may transmit the second message 235 indicating the cell associated with the energy transmitter 205 based on the indicated cell having a highest signal strength among the set of cells (e.g., measured as an RSRP, RSSI, RSRQ, or other signal strength parameters). As such, the energy receiver 210 may select a cell corresponding to a reference signal 230 with a highest signal strength if the corresponding energy transmitter 205 supports energy harvesting.

Alternatively, the energy receiver 210 may be configured (e.g., by an upper layer) to compute a metric (e.g., cellRSQuality_cell_i) for each cell (e.g., each cell i) based one measuring one or more reference signals 230 transmitted by the one or more energy transmitters 205. For example, the energy receiver 210 may generate the metric based on averaging RSRP measurements of all reference signals 230 transmitted from one or more energy transmitters 205 in a time period (e.g., four consecutive reference signals). Alternatively, the energy receiver 210 may generate the metric using a highest (e.g., strongest) RSRP measurement among all reference signals 230 transmitted by one or more energy transmitters 205 and measured in a time period. In some examples, the energy receiver 210 may generate the metric based on averaging a quantity X of the highest RSRP measurements within a time period where the quantity X is less than a predefined value Y. In some cases, the energy receiver 210 may generate the metric based on averaging all RSRPs measured for all reference signals 230 transmitted by the one or more energy transmitters 205 with a value (e.g., in dBm) above a particular threshold value Z (e.g., RSRP>Z dBm). In addition, the energy transmitter 205 may preconfigure or dynamically indicate the values X, Y, and Z. In some cases, energy receiver 210 may select the cell based on the value of the metric, and transmit the second message 235 to the energy transmitter 205 indicating the selected cell.

The energy receiver 210 may be configured to apply a measurement offset (e.g., cellRSoffset_i) to a reference signal measurement for each cell i to perform cell selection. The measurement offset may be indicated by the corresponding cell based on a coverage or transmit power of the cell, and an operator priority handling configuration. In some examples, the energy receiver 210 may calculate a measurement offset cellRSQuality_cell_i−cellRSoffset_i to determine whether an energy transmitter 205 supports sufficient energy harvesting for the energy receiver 210. For example, the energy receiver 210 may refrain from camping on a cell where cellRSQuality_cell_i−cellRSoffset_i<0. Additionally, or alternatively, the energy receiver 210 may rank the cells based on their respective measurement offsets and determine to camp on a cell with a highest quality ranking (e.g., a largest cellRSQuality_cell_i parameter or a highest cellRSQuality_cell_i−cellRSoffset_i).

Upon selecting a cell, the energy receiver 210 may backscatter a PCI corresponding to the selected cell directly to the energy transmitter 205 via the second message 235. If multiple energy receivers 210 are communicating with the energy transmitter 205, each energy receiver 210 may backscatter a waveform to respective energy transmitters 205 at a same time and a same frequency. To avoid a collision between the multiple waveforms, each energy receiver 210 may use a different repetition number for backscattering the cell information (e.g., the PCI). That is, each backscatter frequency link and a corresponding PCI corresponding to a respective energy receiver 210 may have a different repetition number.

Additionally, or alternatively, a backscatter link frequency may be linked to a particular cell identifier (e.g., a particular PCI), where different cells may correspond to different resource pools. As such, each energy receiver 210 may use different frequency resources, time resources, or a combination thereof to backscatter respective cell information to the energy transmitter 205 while avoiding collisions, where tag hashing for an energy receiver 210 may be based on a tag identifier (e.g., an identifier of the respective energy receiver 210). Alternatively, the different cells may correspond to a common resource pool, where the tag hashing may be based on both the tag identifier and the cell identifier (e.g., a PCI), where the energy receiver 210 may backscatter the tag identifier to the energy transmitter 205 in addition to the cell identifier. In some examples, using the mapping between the set of cell identifiers and the set of one or more resources, the energy receiver 210 may backscatter the cell information at a preconfigured frequency (e.g., using a mapping rule between a set of PCIs and a frequency shift).

By performing cell selection based on cell information and reference signals 230 received from one or more energy transmitters 205, communications between an energy transmitter 205 and an energy receiver 210 may be improved. For example, the cell information received in the one or more messages 220 may assist the energy receiver 210 in selecting a cell corresponding to one of the energy transmitters 205 and ensure that the energy transmitter 205 corresponding to the selected cell supports energy harvesting such that the energy receiver 210 may accumulate sufficient energy for communications with the energy transmitter 205. In addition, backscattering the cell information to the energy transmitter 205 in the second message 235 may improve the efficiency and effectiveness of the cell selection process, increasing power reliability for the energy receiver 210, among other benefits.

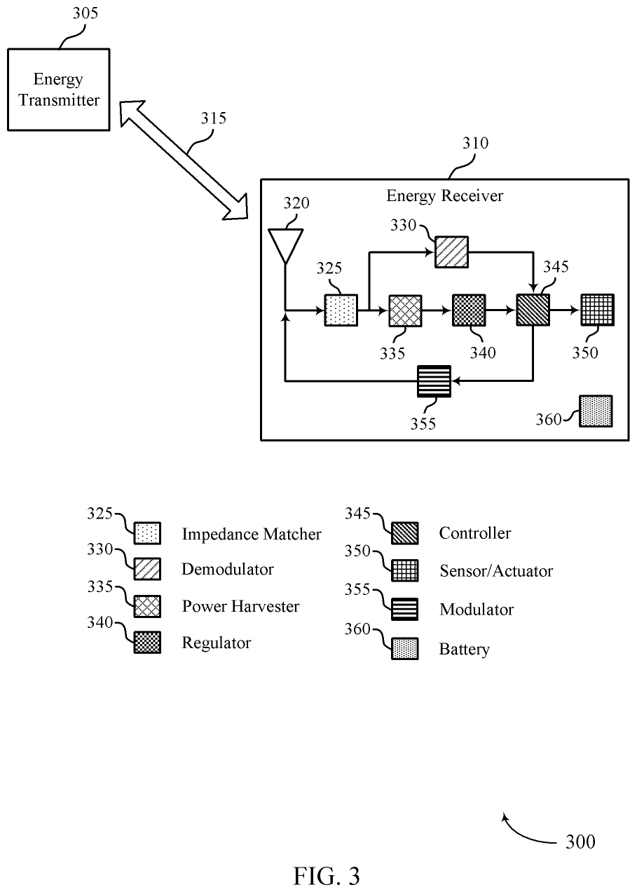

FIG. 3 illustrates an example of a wireless communications system 300 that supports cell selection of a passive device in accordance with one or more aspects of the present disclosure. The wireless communications system 300 may implement or be implemented by aspects of the wireless communications systems 100 and 200 described with reference to FIGS. 1 and 2, respectively. For example, the wireless communications system 300 may include an energy transmitter 305 and an energy receiver 310, which may be examples of the corresponding devices described with reference to FIGS. 1 and 2.

The wireless communications system 300 may support communications between the energy transmitter 305 and the energy receiver 310. For example, the energy transmitter 305 may communicate signals with the energy receiver 310 over a communication link 315, which may be an example of a communication link 125 or a communication link 215 described with reference to FIGS. 1 and 2, respectively. The wireless communications system 300 may support cell selection by the energy receiver 310 based on cell information and reference signals transmitted by one or more energy transmitters 305, as described with reference to FIG. 2.

The energy receiver 310 may include various components to support the communication of signaling with the energy transmitter 305. For example, the energy receiver 310 may include an antenna 320 that supports the reception of signals transmitted by the energy transmitter 305 and the transmission of signals to the energy transmitter 305. The energy receiver 310 may also include an impedance matcher 325 (e.g., coupled with the antenna 320). The impedance matcher 325 may be a fixed or adjustable component that may set an impedance of a line from the antenna 320. Absorption or reflection of signals received at the antenna 320 may be based on an impedance of the impedance matcher 325.

The energy receiver 310 may include a power harvester 335 that is operable to harvest energy from energy signals received from the energy transmitter 305. For example, energy signals received from the energy transmitter 305 may be routed to the power harvester 335, which may harvest energy from the energy signals to power one or more components of the energy receiver 310. In some examples, the energy receiver 310 may include a regulator 340 that is operable to regulate the energy harvested by the power harvester 335. For example, the regulator 340 may regulate the energy to a voltage or a current that is compatible with the one or more components powered by the energy.

In addition, the energy receiver 310 may include a demodulator 330 that is operable to demodulate signals received from the energy transmitter 305 and send the demodulated signals to a controller 345 included in the energy receiver 310. In some examples, the controller 345 may be an example of a microcontroller. The controller 345 may process the demodulated signals and perform one or more operations based on the information included in the demodulated signals. For example, the controller 345 may operate a sensor 350 or an actuator 350 included in (e.g., or coupled with, connected to) the energy receiver 310 in accordance with the information. For instance, the controller 345 may activate the sensor 350, deactivate the sensor 350, read a measurement taken by the sensor 350, activate the actuator 350, deactivate the actuator 350, or a combination thereof, among other operations that the controller 345 may perform.

In some examples, the controller 345 may send signaling to a modulator 355 that is to be transmitted to the energy transmitter 305. The modulator 355 may modulate the signaling in accordance with an MCS and send the modulated signaling to the antenna 320 for transmission. For example, the modulator 355 may modulate an energy signal based on determined CSI and send the modulate energy signal to the antenna 320 for transmission to the energy transmitter 305. Additionally, the modulator 355 may modulate identification information associated with the energy receiver 310, data, information associated with operation of the energy receiver 310, or information associated with the sensor 350 or the actuator 350, among other types of signaling that may be modulated by the modulator 355 and transmitted to the energy transmitter 305.

The wireless communications system 300 may support various types of energy receivers 310. For example, a first type of energy receiver 310 may correspond to an energy receiver 310 that excludes or is unconnected from a power source, such as a battery 360 (although other types of power sources are possible). Here, the components of the energy receiver 310 may be powered by the energy harvested from energy signals received at the energy receiver 310. For example, an RFID tag may operate without a battery 360 at low operating expenses, a low maintenance cost, and a long life-cycle. A second type of energy receiver 310 may correspond to an energy receiver 310 that includes or is connected to a power source, such as the battery 360. Here, the components of the energy receiver 310 may be powered by the energy harvested from energy signals, the battery 360, or a combination thereof. In some examples, the power harvested from the energy signals may be used to charge the battery 360, which may increase a battery life of the battery 360 and reduce a frequency at which the battery 360 is replaced, among other benefits.

In some examples, one or more energy transmitters 305 may transmit one or more messages to the energy receiver 310, each message identifying a cell associated with an energy transmitter 305 and indicating one or more resources on which the energy receiver 310 may receive a reference signal for cell selection. After receiving one or more reference signals on the one or more resources, the energy receiver 310 may select a cell (e.g., based on signal strength measurements of the reference signals) and backscatter cell information for the selected cell back to the energy transmitter 305. The cell selection process may support different types of energy receivers 310. For example, an energy receiver 310 of the first type (e.g., an RFID tag, a passive IoT device) may have deterministic energy charging opportunities, which may be adapted to the particular type and quantity of energy receivers 310 in communications with the energy transmitter 305, and may be a consideration in the cell selection process (e.g., the energy receiver 310 may communicate with energy transmitters 305 that support cell selection).

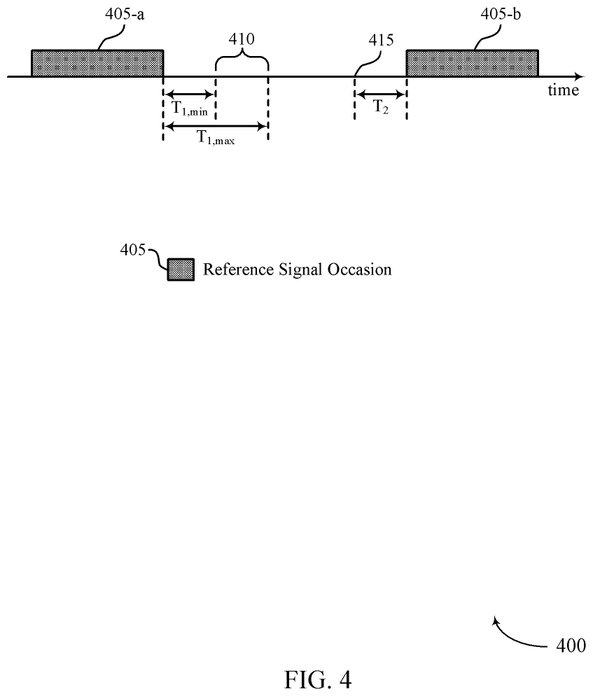

FIG. 4 illustrates an example of a timeline 400 that supports cell selection of a passive device in accordance with one or more aspects of the present disclosure. The timeline 400 may implement or be implemented by aspects of the wireless communications system 100 and 200 as described with reference to FIG. 1 and FIG. 2. For example, an energy receiver (e.g., a passive device, an RFID tag) may receive reference signals from one or more energy transmitters (e.g., a network entity), perform cell selection based on the reference signals, and backscatter cell information corresponding to a selected cell back to the energy transmitter in accordance with the timeline 400.

As described herein, an energy receiver may receive one or more messages from one or more energy transmitters, each message identifying a cell associated with an energy transmitter and indicating one or more resources (e.g., frequency resources, time resources, or a combination thereof) on which the energy receiver may receive one or more reference signals from one or more energy transmitters. In addition, each message may indicate whether a respective energy transmitter supports energy harvesting, among other cell information. The energy receiver may receive the one or more reference signals on the one or more resources, and select a cell based on measuring a signal strength of the reference signals (e.g., RSRP, RSSI, or RSRQ measurements). Upon selecting a cell, the energy receiver may backscatter corresponding cell information to the energy transmitter. That is, the energy receiver may transmit a second message to the energy transmitter, the second message indicating an identifier (e.g., a PCI) of the selected cell.

In some examples, the energy receiver may backscatter the cell information according to the timeline 400. For example, the energy receiver may be configured to perform the cell selection and backscatter the PCI of the selected cell based on at least X reference signal measurements (e.g., a specific quantity of signal strength measurements for the received reference signals). The energy receiver may backscatter the cell information to the energy transmitter after an immediate reference signal occasion 405 within a time period 410 spanning a minimum time to a maximum time (e.g., [T_{1,min}, T_{1,max}]). For example, the energy receiver may receive a first reference signal from a first energy receiver during a reference signal occasion 405-a. During the time period 410 between a minimum time T_{1,min} and a maximum time T_{1,max}, the energy receiver may begin backscattering cell information corresponding to the selected cell to the energy transmitter. That is, during a time period between the end of the reference signal occasion 405-a and the minimum time T_{1,min}, the energy receiver may perform signal strength measurements on the received reference signal and select a cell based on the reference signals measurements and the corresponding energy transmitter supporting energy harvesting.

The energy receiver may continue to backscatter the information to the energy transmitter (e.g., in some cases, according to a repetition number) until a time 415, which may be at least a time period T2 before a reference signal occasion 405-b (e.g., the next reference signal occasion 405). That is, the energy receiver may backscatter the cell information selected based on measurements of one or more reference signals transmitted in the reference signal occasion 405-a before performing additional measurements of one or more reference signals transmitted in the reference signal occasion 405-b. Accordingly, the energy receiver may increase the efficiency and effectiveness of cell selection.

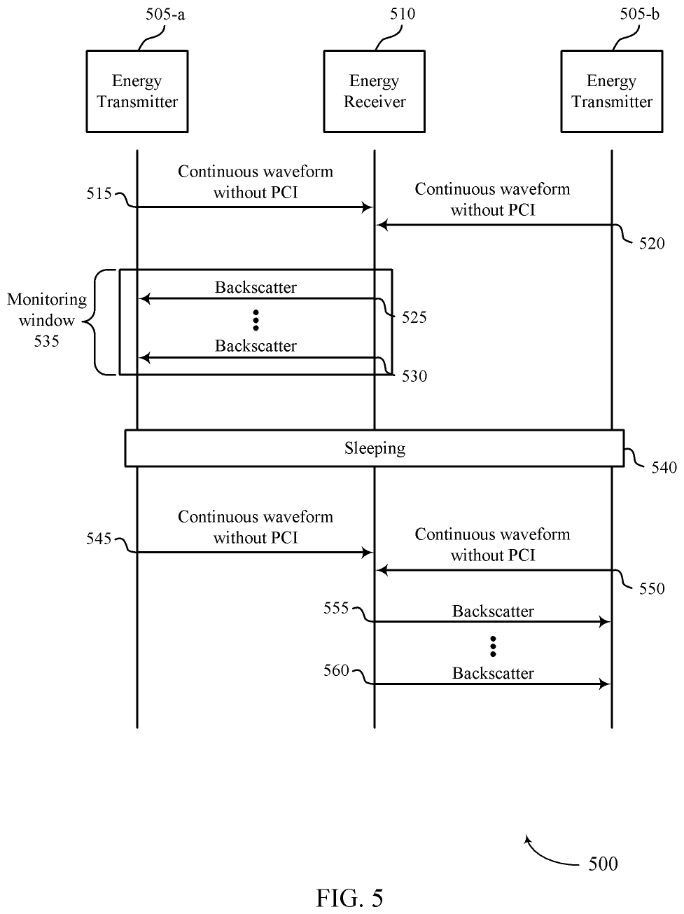

FIG. 5 illustrates an example of a process flow 500 that supports cell selection of a passive device in accordance with one or more aspects of the present disclosure. The process flow 500 may implement aspects of wireless communications systems 100 and 200, or may be implemented by aspects of the wireless communications system 100 and 200. For example, the process flow 500 may illustrate operations between an energy transmitter 505-a, an energy transmitter 505-b, and an energy receiver 510, which may be examples of corresponding devices described herein. In the following description of the process flow 500, the operations between the energy transmitter 505-a, the energy transmitter 505-b, and the energy receiver 510 may be transmitted in a different order than the example order shown, or the operations performed by the energy transmitter 505-a, the energy transmitter 505-b, and the energy receiver 510 may be performed in different orders or at different times. Some operations may also be omitted from the process flow 500, and other operations may be added to the process flow 500.

At 515, the energy receiver 510 may receive a continuous waveform (e.g., a message) identifying cell information without a PCI from the energy transmitter 505-a. That is, the waveform may not include a cell identifier associated with the energy transmitter 505-a.

At 520, the energy receiver 510 may receive a continuous waveform identifying cell information without a PCI from the energy transmitter 505-b. That is, the energy receiver 510 may receive messages from the energy transmitter 505-a, the energy transmitter 505-b, or both, which may support energy harvesting. In addition, the energy receiver 510 may receive one or more reference signals from the energy transmitter 505-a, the energy transmitter 505-b, or both.

At 525, after performing a measurement procedure on the one or more reference signals (e.g., measuring an RSRP, an RSSI, an RSRP, or other signal strength indicators), the energy receiver 510 may select a cell and backscatter cell information corresponding to the selected cell to the energy transmitter 505-a, where the energy transmitter 505-a may be associated with the selected cell. The cell information may include a PCI of the selected cell, among other cell information. In some examples, the energy receiver 510 may maintain a timer that starts when the energy receiver 510 begins to backscatter the cell information.

At 530, the energy receiver 510 may repeat the backscattering during a monitoring window 535 until the energy receiver 510 receives a response from the energy transmitter 505-a or until the timer expires.

At 540, if the energy transmitter 505-a fails to respond to the energy receiver 510, the energy receiver 510 may maintain the timer and enter a sleep mode during the timer. In some examples, the energy receiver 510 may wake up and select a new cell and corresponding PCI to backscatter to the energy transmitter 505-a.

At 545, the energy receiver 510 may receive a second continuous waveform identifying cell information without a PCI from the energy transmitter 505-a.

At 550, the energy receiver 510 may receive a second continuous waveform identifying cell information without a PCI from the energy transmitter 505-b. In such case, if the energy receiver 310 selects a cell and identifies a corresponding PCI associated with the energy transmitter 505-b, the energy receiver 310 may reset the timer (e.g., or a counter) and begin a new series of backscattering the cell information to the energy transmitter 505-b.

At 555, the energy receiver 510 may backscatter the cell information corresponding to the selected cell to the energy transmitter 505-b, where the energy transmitter 505-b may be associated with the selected cell. The cell information may include a PCI of the selected cell and other cell information.

At 560, the energy receiver 510 may repeat the backscattering until the energy receiver 510 reaches a maximum quantity of allowed repetitions of backscattering, or until the energy receiver 510 receives a response from the energy transmitter 505-b. Similarly, if the energy receiver 510 fails to receive a response from the energy transmitter 505-b, the energy receiver 510 may select a different cell and corresponding PCI to backscatter.

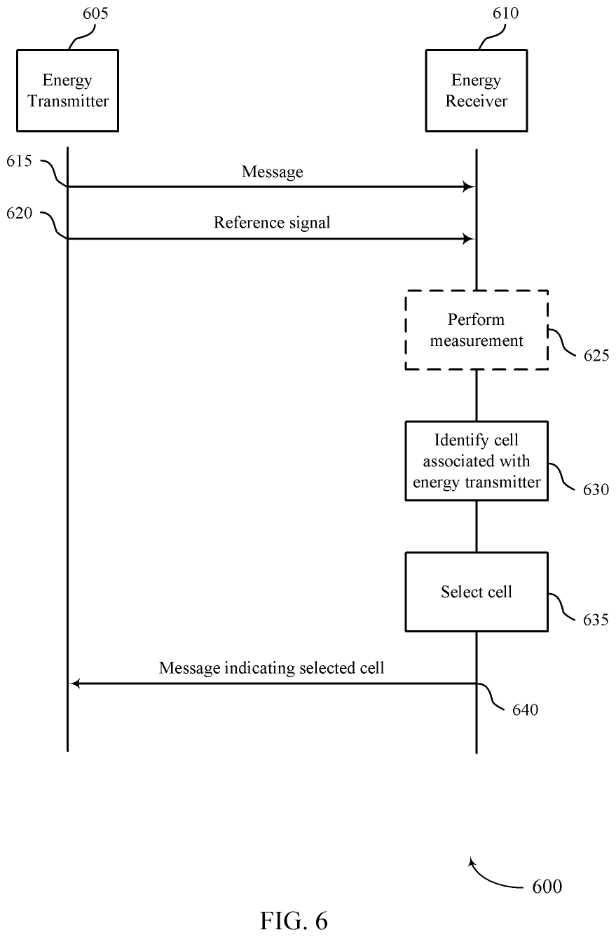

FIG. 6 illustrates an example of a process flow 600 that supports cell selection of a passive device in accordance with one or more aspects of the present disclosure. The process flow 600 may implement aspects of wireless communications systems 100 and 200, or may be implemented by aspects of the wireless communications system 100 and 200. For example, the process flow 600 may illustrate operations between an energy transmitter 605 and an energy receiver 510, which may be examples of corresponding devices described herein. In the following description of the process flow 600, the operations between the energy transmitter 605 and the energy receiver 610 may be transmitted in a different order than the example order shown, or the operations performed by the energy transmitter 605 and the energy receiver 610 may be performed in different orders or at different times. Some operations may also be omitted from the process flow 600, and other operations may be added to the process flow 600.

At 615, the energy receiver 610 may receive one or more messages from respective one or more energy transmitter devices including the energy transmitter 605, each message of the one or more messages identifying a cell associated with the energy transmitter 605 of the one or more energy transmitter devices and indicating one or more resources for reception of a reference signal from the energy transmitter 605 for cell selection. In addition, the one or more messages may indicate whether the energy transmitter 605 supports energy harvesting, what types of energy receivers 610 the energy transmitter 605 supports, and other cell information.

At 620, the energy receiver 610 may receive, from the one or more energy transmitter devices including the energy transmitter 605, the reference signal on the one or more resources. The resources may include frequency domain resources, time resources, or any combination thereof.

At 625, the energy receiver 610 may perform a measurement procedure of the reference signal from one or more cells including the cell associated with the energy transmitter 605. For example, the energy receive 610 may measure a channel quality or a signal strength value of the reference signal such as an RSSI, an RSRP, or an RSRQ.

At 630, the energy receiver 610 may identify a cell associated with the energy transmitter 605 based on an orthogonal sequence of the one or more messages, where each of the one or more energy transmitter devices including the energy transmitter 605 is associated with one of a set of orthogonal sequences that include the orthogonal sequence. Alternatively, the energy receiver 610 may identify the cell associated with the energy transmitter 605 based on a resource associated with the one or more messages, where each one of the one or more energy transmitter devices is associated with one of a set of resources that include the resource, the resource being a frequency resource, a time resource, or a combination thereof. In some examples, the energy receiver 610 may identifier a cell identifier of the cell based on a mapping between a set of cell identifiers (e.g., PCIs) and a corresponding set of resources (e.g., frequency resources, time resources, or both) used for the one or more messages.

At 635, the energy receiver 610 may select the cell based on the reference signals and the energy transmitter 605 supporting energy harvesting. In some examples, the cell selection may be based on measuring a signal strength of the reference signal. In addition, the energy receiver 610 may select the cell corresponding to an energy transmitter 605 that supports energy harvesting to ensure that the energy receiver 610 may harvest sufficient energy to communicate with the energy transmitter 605.

At 640, the energy receiver 610 may transmit, to the energy transmitter 605, a second message that indicates the cell associated with the energy transmitter 605 of the one or more energy transmitter devices, the cell selected by the energy receiver 610 based on the reference signal and the energy transmitter 605 supporting energy harvesting. In some examples, the second message may include a PCI of the selected cell (e.g., the energy receiver 610 may backscatter cell information corresponding to the selected cell.

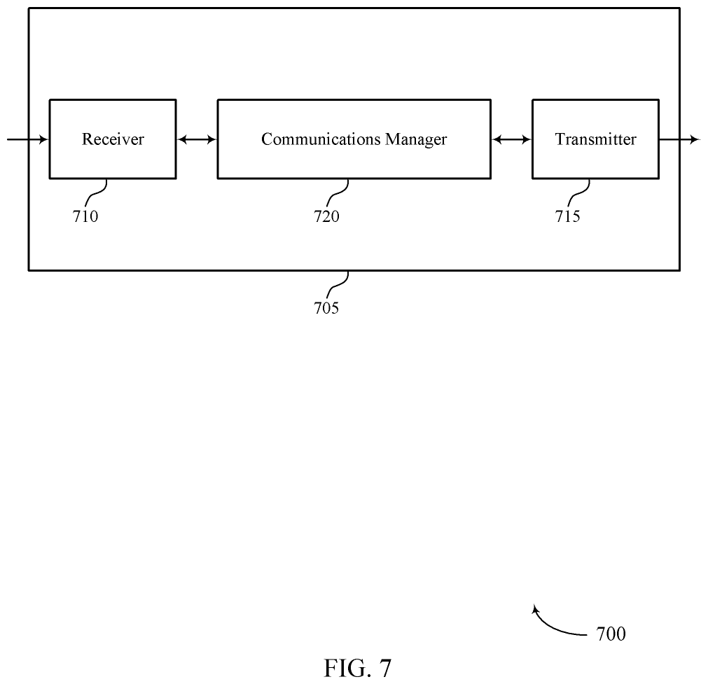

FIG. 7 shows a block diagram 700 of a device 705 that supports cell selection of a passive device in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to cell selection of a passive device). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cell selection of a passive device). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of cell selection of a passive device as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at an energy receiver device in accordance with examples as disclosed herein. For example, the communications manager 720 may be configured as or otherwise support a means for receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The communications manager 720 may be configured as or otherwise support a means for receiving, from the one or more energy transmitter devices, the reference signal on the one or more resources. The communications manager 720 may be configured as or otherwise support a means for transmitting a second message that indicates a cell associated with one of the one or more energy transmitter devices, the cell selected by the energy receiver device based on the reference signal and the one of the one or more energy transmitter devices supporting energy harvesting.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for cell selection by a passive device based on cell information and reference signals transmitted from one or more energy transmitter devices, which may increase power harvesting by the passive device and improve communication between devices.

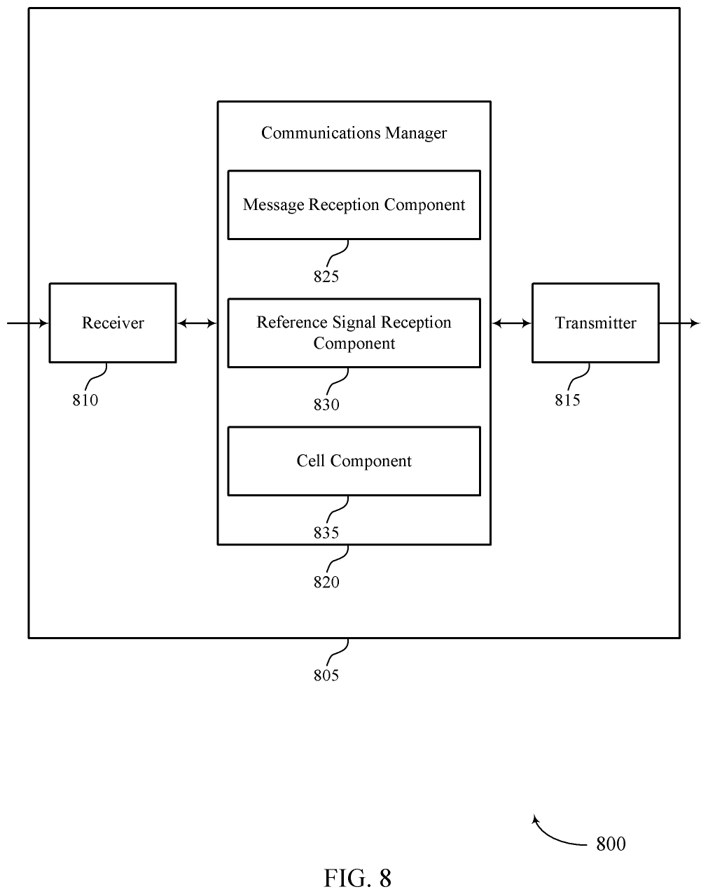

FIG. 8 shows a block diagram 800 of a device 805 that supports cell selection of a passive device in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to cell selection of a passive device). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to cell selection of a passive device). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of cell selection of a passive device as described herein. For example, the communications manager 820 may include a message reception component 825, a reference signal reception component 830, a cell component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at an energy receiver device in accordance with examples as disclosed herein. The message reception component 825 may be configured as or otherwise support a means for receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The reference signal reception component 830 may be configured as or otherwise support a means for receiving, from the one or more energy transmitter devices, the reference signal on the one or more resources. The cell component 835 may be configured as or otherwise support a means for transmitting a second message that indicates a cell associated with one of the one or more energy transmitter devices, the cell selected by the energy receiver device based on the reference signal and the one of the one or more energy transmitter devices supporting energy harvesting.

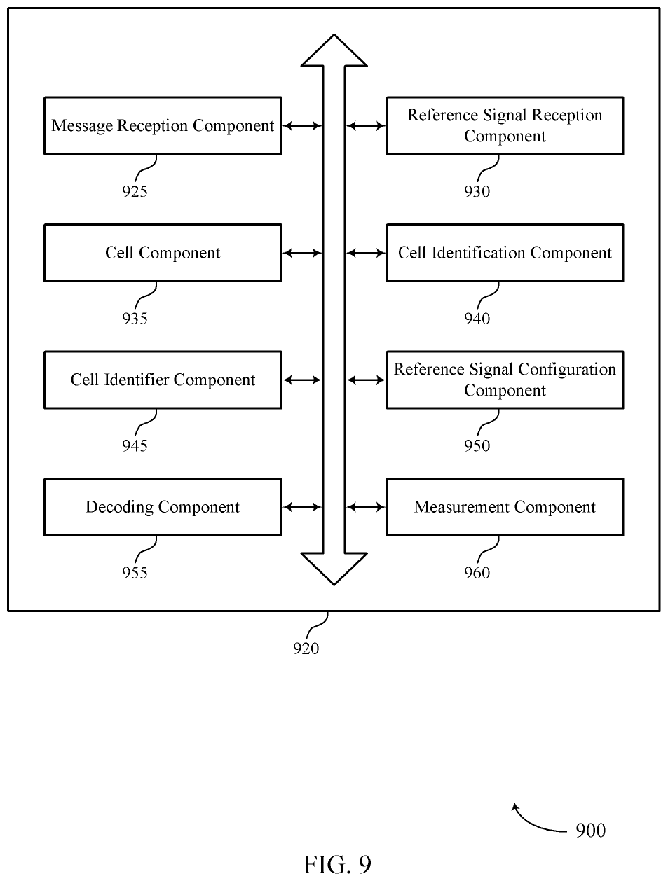

FIG. 9 shows a block diagram 900 of a communications manager 920 that supports cell selection of a passive device in accordance with one or more aspects of the present disclosure. The communications manager 920 may be an example of aspects of a communications manager 720, a communications manager 820, or both, as described herein. The communications manager 920, or various components thereof, may be an example of means for performing various aspects of cell selection of a passive device as described herein. For example, the communications manager 920 may include a message reception component 925, a reference signal reception component 930, a cell component 935, a cell identification component 940, a cell identifier component 945, a reference signal configuration component 950, a decoding component 955, a measurement component 960, or any combination thereof. Each of these components may communicate, directly or indirectly, with one another (e.g., via one or more buses).

The communications manager 920 may support wireless communication at an energy receiver device in accordance with examples as disclosed herein. The message reception component 925 may be configured as or otherwise support a means for receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The reference signal reception component 930 may be configured as or otherwise support a means for receiving, from the one or more energy transmitter devices, the reference signal on the one or more resources. The cell component 935 may be configured as or otherwise support a means for transmitting a second message that indicates a cell associated with one of the one or more energy transmitter devices, the cell selected by the energy receiver device based on the reference signal and the one of the one or more energy transmitter devices supporting energy harvesting.

In some examples, to support receiving the one or more messages, the message reception component 925 may be configured as or otherwise support a means for receiving the one or more messages from the respective one or more energy transmitter devices, each message of the one or more messages indicating whether the energy transmitter device supports energy harvesting.

In some examples, the cell identification component 940 may be configured as or otherwise support a means for identifying the cell associated with the energy transmitter device based on an orthogonal sequence of the one or more messages, where each of the one or more energy transmitter devices is associated with one of a set of orthogonal sequences that include the orthogonal sequence.

In some examples, the cell identification component 940 may be configured as or otherwise support a means for identifying the cell associated with the energy transmitter device based on a resource associated with the one or more messages, where each of the one or more energy transmitter devices is associated with one of a set of resources that include the resource, and the resource includes a frequency resource, a time resource, or a combination thereof.

In some examples, the cell identifier component 945 may be configured as or otherwise support a means for identifying a cell identifier for the cell based on a mapping between a set of cell identifiers and a corresponding set of resources used for the one or more messages, where the set of resources include frequency resources, time resources, or a combination thereof.

In some examples, to support receiving the one or more messages, the message reception component 925 may be configured as or otherwise support a means for receiving the one or more messages from the respective one or more energy transmitter devices, each message of the one or more messages indicating at least one type of energy receiver device supported by the energy transmitter device transmitting the message.

In some examples, to support receiving the one or more messages, the reference signal configuration component 950 may be configured as or otherwise support a means for receiving the one or more messages from the respective one or more energy transmitter devices, each message of the one or more messages indicating a configuration of the reference signal, the configuration indicating a periodicity of the reference signal, a quantity of reference signals to be transmitted by the energy transmitter device, or a combination thereof. In some examples, to support receiving the one or more messages, the reference signal configuration component 950 may be configured as or otherwise support a means for receiving the reference signal on the one or more resources in accordance with the configuration. In some examples, to support receiving the one or more messages, the reference signal configuration component 950 may be configured as or otherwise support a means for selecting the cell based on the configuration and the periodicity of the reference signal.

In some examples, to support receiving the one or more messages, the message reception component 925 may be configured as or otherwise support a means for receiving the one or more messages from the respective one or more energy transmitter devices, each message of the one or more messages indicating a maximum repetition associated with the second message.

In some examples, the decoding component 955 may be configured as or otherwise support a means for decoding the one or more messages received from the respective one or more energy transmitter devices. In some examples, the decoding component 955 may be configured as or otherwise support a means for transmitting the second message based on successfully decoding the one or more messages.

In some examples, the measurement component 960 may be configured as or otherwise support a means for transmitting the second message based on a signal strength value of a measurement of the reference signal exceeding a threshold.

In some examples, the measurement component 960 may be configured as or otherwise support a means for performing a measurement procedure of a reference signal from a set of multiple cells that include the cell. In some examples, the measurement component 960 may be configured as or otherwise support a means for transmitting the second message indicating the cell based on the indicated cell having a highest signal strength among the set of multiple cells.

In some examples, the measurement component 960 may be configured as or otherwise support a means for generating a metric for each cell associated with the one or more energy transmitter devices based on an average measured RSRP for one or more reference signals received in a time period, a highest measured RSRP of a reference signal in a time window, an average measured RSRP of one or more highest measured RSRPs for one or more reference signals, or an averaged measured RSRP of one or more RSRPs above a threshold for one or more reference signals. In some examples, the measurement component 960 may be configured as or otherwise support a means for selecting the cell based on the metric.

In some examples, to support transmitting the second message, the cell component 935 may be configured as or otherwise support a means for transmitting the second message that indicates a PCI associated with the cell selected by the energy receiver device, where each message of the one or more messages indicates a PCI identifier.

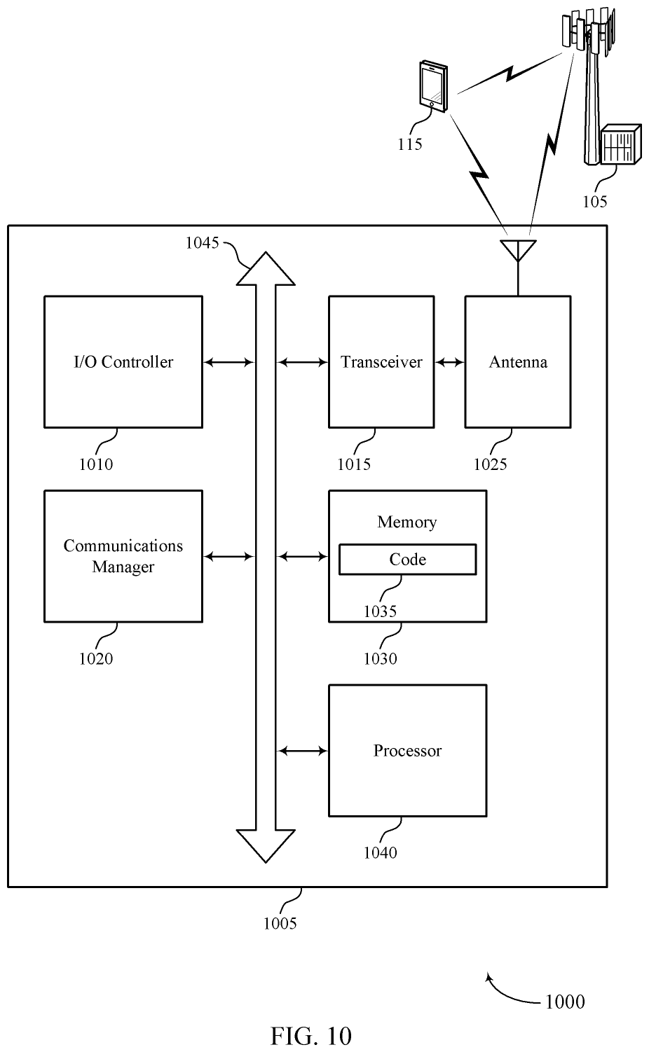

FIG. 10 shows a diagram of a system 1000 including a device 1005 that supports cell selection of a passive device in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, or electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a graphics processing unit (GPU), a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting cell selection of a passive device). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at an energy receiver device in accordance with examples as disclosed herein. For example, the communications manager 1020 may be configured as or otherwise support a means for receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The communications manager 1020 may be configured as or otherwise support a means for receiving, from the one or more energy transmitter devices, the reference signal on the one or more resources. The communications manager 1020 may be configured as or otherwise support a means for transmitting a second message that indicates a cell associated with one of the one or more energy transmitter devices, the cell selected by the energy receiver device based on the reference signal and the one of the one or more energy transmitter devices supporting energy harvesting.

By including or configuring the communications manager 1020 in accordance with examples as described herein, the device 1005 may support techniques for cell selection by a passive device based on cell information and reference signals transmitted from one or more energy transmitter devices, which may increase power harvesting by the passive device and improve communication between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of cell selection of a passive device as described herein, or the processor 1040 and the memory 1030 may be otherwise configured to perform or support such operations.

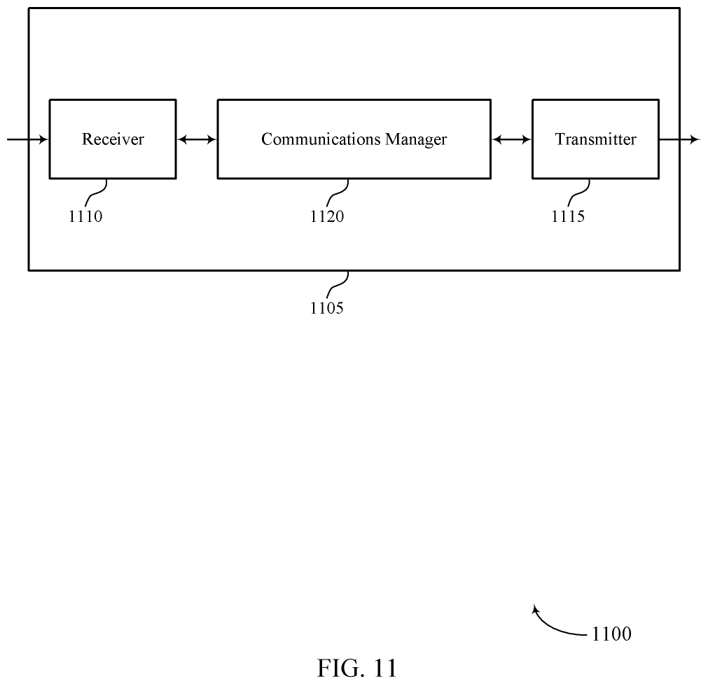

FIG. 11 shows a block diagram 1100 of a device 1105 that supports cell selection of a passive device in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of cell selection of a passive device as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by at least one processor. If implemented in code executed by at least one processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at an energy transmitter device in accordance with examples as disclosed herein. For example, the communications manager 1120 may be configured as or otherwise support a means for transmitting one or more messages to an energy receiver device, each message of the one or more messages identifying a cell associated with the energy transmitter device of one or more energy transmitter devices and indicating one or more resources for reception of a reference signal by the energy receiver device for cell selection. The communications manager 1120 may be configured as or otherwise support a means for transmitting, to the energy receiver device, the reference signal on the one or more resources. The communications manager 1120 may be configured as or otherwise support a means for receiving a second message that indicates a cell associated with one of the one or more energy transmitter devices, the cell selected by the energy receiver device based on the reference signal and the one of the one or more energy transmitter devices supporting energy harvesting.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for cell selection by a passive device based on cell information and reference signals transmitted from one or more energy transmitter devices, which may increase power harvesting by the passive device and improve communication between devices.

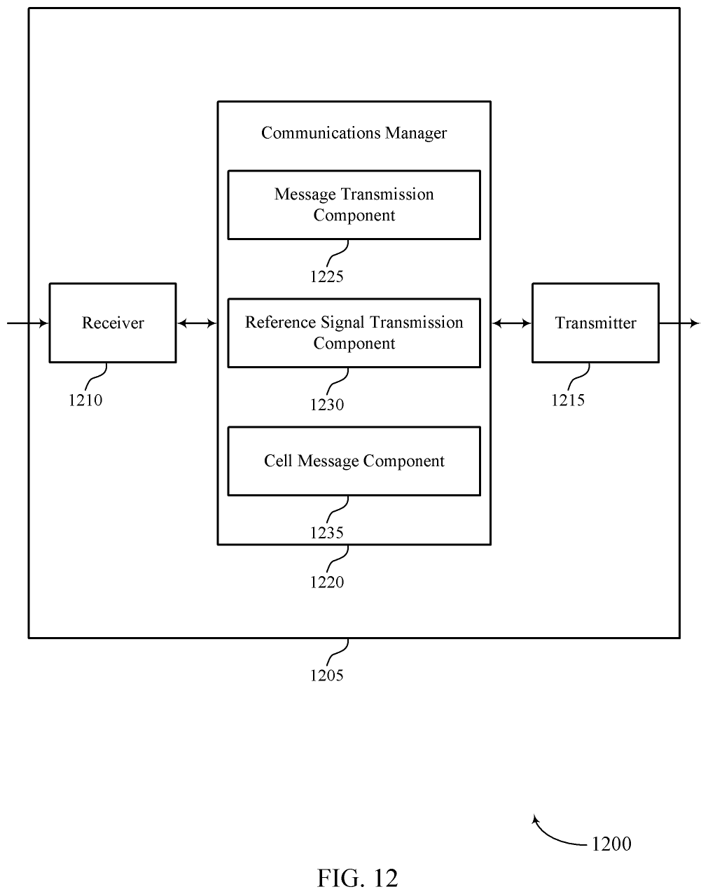

FIG. 12 shows a block diagram 1200 of a device 1205 that supports cell selection of a passive device in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of cell selection of a passive device as described herein. For example, the communications manager 1220 may include a message transmission component 1225, a reference signal transmission component 1230, a cell message component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at an energy transmitter device in accordance with examples as disclosed herein. The message transmission component 1225 may be configured as or otherwise support a means for transmitting one or more messages to an energy receiver device, each message of the one or more messages identifying a cell associated with the energy transmitter device of one or more energy transmitter devices and indicating one or more resources for reception of a reference signal by the energy receiver device for cell selection. The reference signal transmission component 1230 may be configured as or otherwise support a means for transmitting, to the energy receiver device, the reference signal on the one or more resources. The cell message component 1235 may be configured as or otherwise support a means for receiving a second message that indicates a cell associated with one of the one or more energy transmitter devices, the cell selected by the energy receiver device based on the reference signal and the one of the one or more energy transmitter devices supporting energy harvesting.

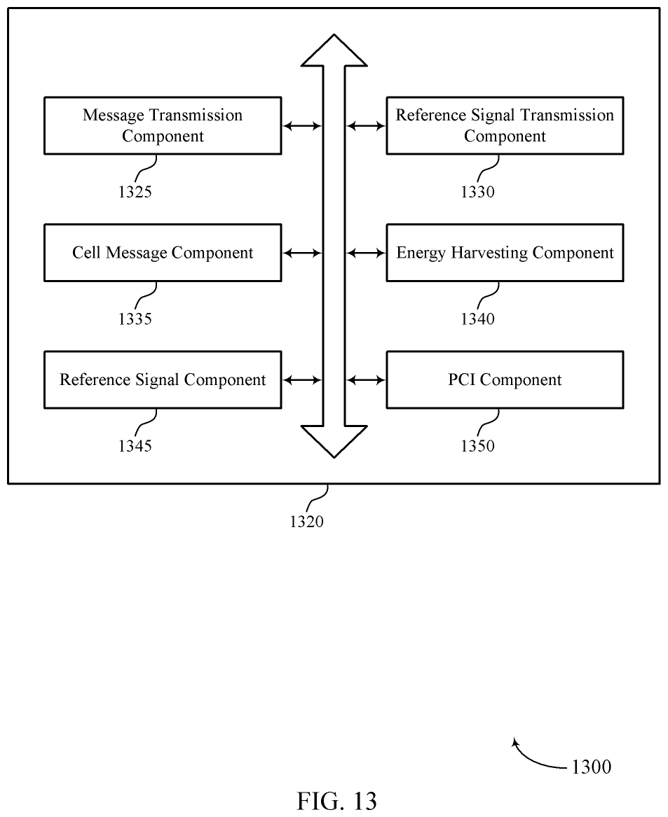

FIG. 13 shows a block diagram 1300 of a communications manager 1320 that supports cell selection of a passive device in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of cell selection of a passive device as described herein. For example, the communications manager 1320 may include a message transmission component 1325, a reference signal transmission component 1330, a cell message component 1335, an energy harvesting component 1340, a reference signal component 1345, a PCI component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at an energy transmitter device in accordance with examples as disclosed herein. The message transmission component 1325 may be configured as or otherwise support a means for transmitting one or more messages to an energy receiver device, each message of the one or more messages identifying a cell associated with the energy transmitter device of one or more energy transmitter devices and indicating one or more resources for reception of a reference signal by the energy receiver device for cell selection. The reference signal transmission component 1330 may be configured as or otherwise support a means for transmitting, to the energy receiver device, the reference signal on the one or more resources. The cell message component 1335 may be configured as or otherwise support a means for receiving a second message that indicates a cell associated with one of the one or more energy transmitter devices, the cell selected by the energy receiver device based on the reference signal and the one of the one or more energy transmitter devices supporting energy harvesting.

In some examples, to support transmitting the one or more messages, the energy harvesting component 1340 may be configured as or otherwise support a means for transmitting the one or more messages from respective one or more energy transmitter devices, each message of the one or more messages indicating whether the energy transmitter device supports energy harvesting.

In some examples, each of the one or more energy transmitter devices is associated with one of a set of orthogonal sequences. In some examples, each of the one or more energy transmitter devices is associated with resources of a set of resources that include the one or more resources, and the one or more resources includes a frequency resource, a time resource, or a combination thereof.

In some examples, each message of the one or more messages identifies the cell based on a mapping between a set of cell identifiers and a corresponding set of resources used for the one or more messages, where the set of resources include frequency resources, time resources, or a combination thereof.

In some examples, to support transmitting the one or more messages, the message transmission component 1325 may be configured as or otherwise support a means for transmitting the one or more messages from respective one or more energy transmitter devices, each message of the one or more messages indicating at least one type of energy receiver device supported by the energy transmitter device transmitting the message.

In some examples, to support transmitting the one or more messages, the reference signal component 1345 may be configured as or otherwise support a means for transmitting the one or more messages from respective one or more energy transmitter devices, each message of the one or more messages indicating a configuration of the reference signal, the configuration indicating a periodicity of the reference signal, a quantity of reference signals to be transmitted by the energy transmitter device, or a combination thereof. In some examples, to support transmitting the one or more messages, the reference signal component 1345 may be configured as or otherwise support a means for transmitting the reference signal on the one or more resources in accordance with the configuration.

In some examples, to support transmitting the one or more messages, the message transmission component 1325 may be configured as or otherwise support a means for transmitting the one or more messages from respective one or more energy transmitter devices, each message of the one or more messages indicating a maximum repetition associated with the second message.

In some examples, to support receiving the second message, the cell message component 1335 may be configured as or otherwise support a means for receiving the second message based on the energy receiver device successfully decoding the one or more messages.

In some examples, to support receiving the second message, the cell message component 1335 may be configured as or otherwise support a means for receiving the second message based on a signal strength value of a measurement of the reference signal exceeding a threshold.

In some examples, to support receiving the second message, the cell message component 1335 may be configured as or otherwise support a means for receiving the second message indicating the cell selected by the energy receiver device based on the cell having a highest signal strength among a set of multiple cells.

In some examples, to support receiving the second message, the PCI component 1350 may be configured as or otherwise support a means for receiving the second message that indicates a PCI associated with the cell selected by the energy receiver device, where each message of the one or more messages indicates a PCI.

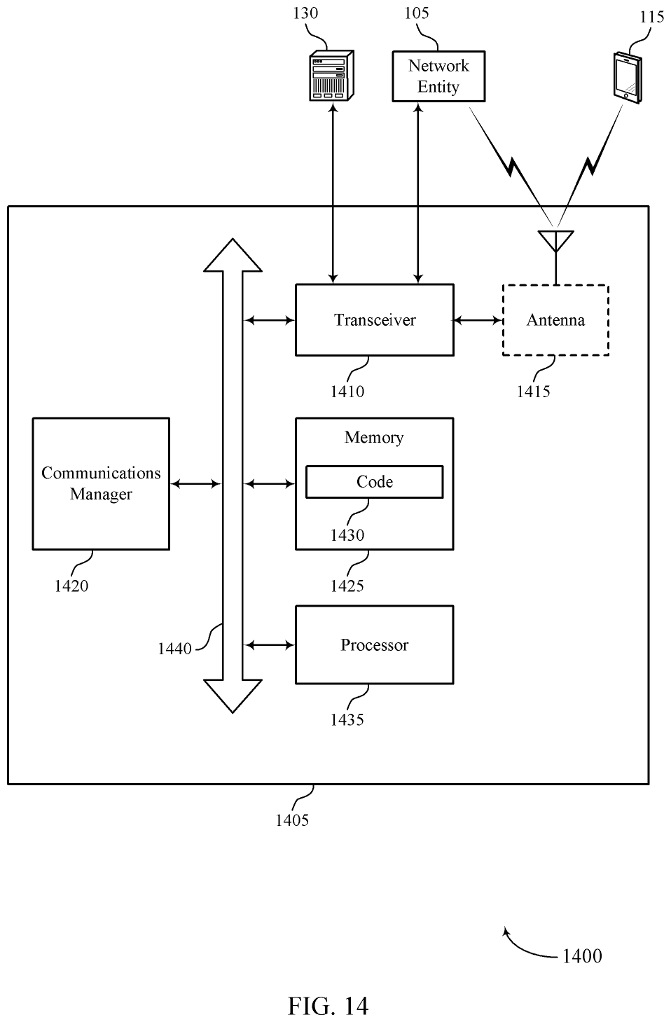

FIG. 14 shows a diagram of a system 1400 including a device 1405 that supports cell selection of a passive device in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, or electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting cell selection of a passive device). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at an energy transmitter device in accordance with examples as disclosed herein. For example, the communications manager 1420 may be configured as or otherwise support a means for transmitting one or more messages to an energy receiver device, each message of the one or more messages identifying a cell associated with the energy transmitter device of one or more energy transmitter devices and indicating one or more resources for reception of a reference signal by the energy receiver device for cell selection. The communications manager 1420 may be configured as or otherwise support a means for transmitting, to the energy receiver device, the reference signal on the one or more resources. The communications manager 1420 may be configured as or otherwise support a means for receiving a second message that indicates a cell associated with one of the one or more energy transmitter devices, the cell selected by the energy receiver device based on the reference signal and the one of the one or more energy transmitter devices supporting energy harvesting.

By including or configuring the communications manager 1420 in accordance with examples as described herein, the device 1405 may support techniques for cell selection by a passive device based on cell information and reference signals transmitted from one or more energy transmitter devices, which may increase power harvesting by the passive device and improve communication between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of cell selection of a passive device as described herein, or the processor 1435 and the memory 1425 may be otherwise configured to perform or support such operations.

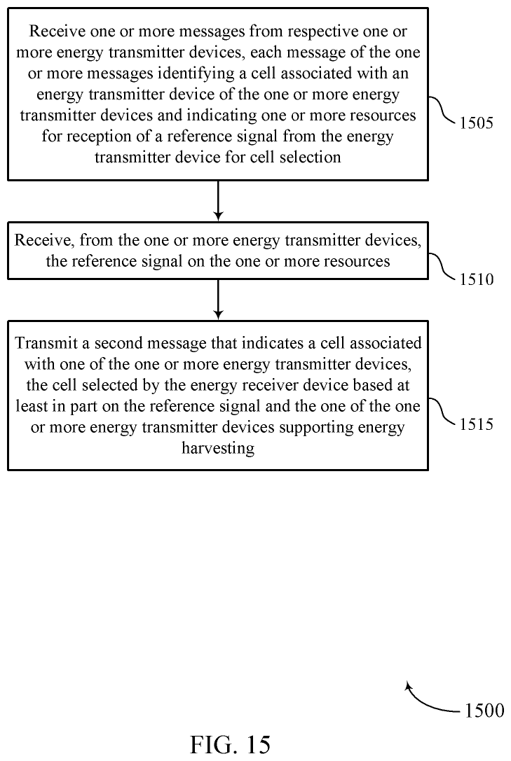

FIG. 15 shows a flowchart illustrating a method 1500 that supports cell selection of a passive device in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The operations of 1505 may be performed in accordance with examples as disclosed herein. In some examples, aspects of the operations of 1505 may be performed by a message reception component 925 as described with reference to FIG. 9.

At 1510, the method may include receiving, from the one or more energy transmitter devices, the reference signal on the one or more resources. The operations of 1510 may be performed in accordance with examples as disclosed herein. In some examples, aspects of the operations of 1510 may be performed by a reference signal reception component 930 as described with reference to FIG. 9.

At 1515, the method may include transmitting a second message that indicates a cell associated with one of the one or more energy transmitter devices, the cell selected by the energy receiver device based at least in part on the reference signal and the one of the one or more energy transmitter devices supporting energy harvesting. The operations of 1515 may be performed in accordance with examples as disclosed herein. In some examples, aspects of the operations of 1515 may be performed by a cell component 935 as described with reference to FIG. 9.

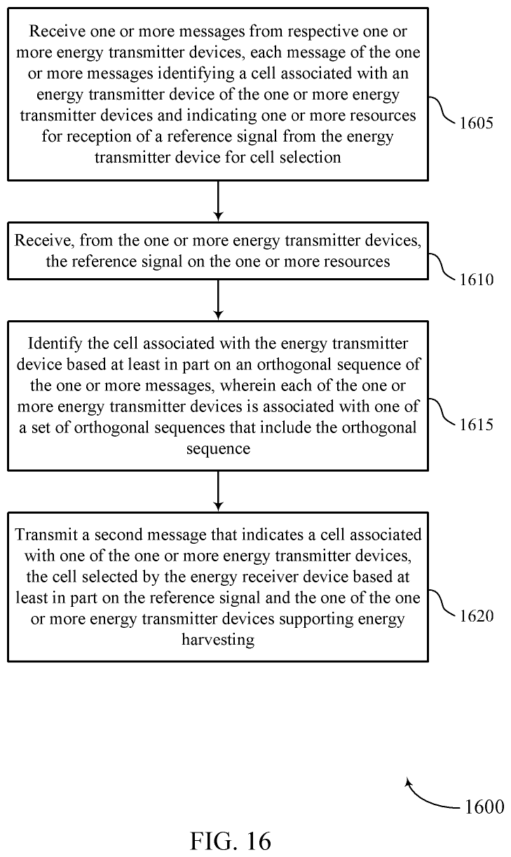

FIG. 16 shows a flowchart illustrating a method 1600 that supports cell selection of a passive device in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The operations of 1605 may be performed in accordance with examples as disclosed herein. In some examples, aspects of the operations of 1605 may be performed by a message reception component 925 as described with reference to FIG. 9.

At 1610, the method may include receiving, from the one or more energy transmitter devices, the reference signal on the one or more resources. The operations of 1610 may be performed in accordance with examples as disclosed herein. In some examples, aspects of the operations of 1610 may be performed by a reference signal reception component 930 as described with reference to FIG. 9.

At 1615, the method may include identifying the cell associated with the energy transmitter device based at least in part on an orthogonal sequence of the one or more messages, wherein each of the one or more energy transmitter devices is associated with one of a set of orthogonal sequences that include the orthogonal sequence. The operations of 1615 may be performed in accordance with examples as disclosed herein. In some examples, aspects of the operations of 1615 may be performed by a cell identification component 940 as described with reference to FIG. 9.

At 1620, the method may include transmitting a second message that indicates a cell associated with one of the one or more energy transmitter devices, the cell selected by the energy receiver device based at least in part on the reference signal and the one of the one or more energy transmitter devices supporting energy harvesting. The operations of 1620 may be performed in accordance with examples as disclosed herein. In some examples, aspects of the operations of 1620 may be performed by a cell component 935 as described with reference to FIG. 9.

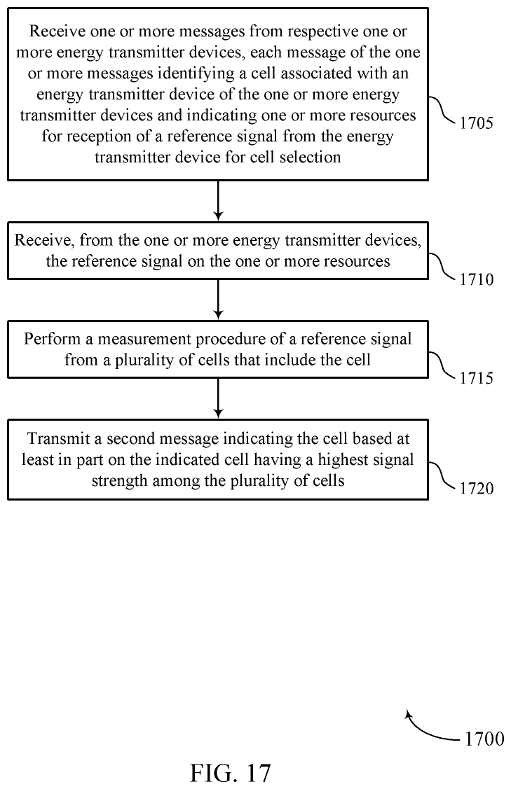

FIG. 17 shows a flowchart illustrating a method 1700 that supports cell selection of a passive device in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection. The operations of 1705 may be performed in accordance with examples as disclosed herein. In some examples, aspects of the operations of 1705 may be performed by a message reception component 925 as described with reference to FIG. 9.

At 1710, the method may include receiving, from the one or more energy transmitter devices, the reference signal on the one or more resources. The operations of 1710 may be performed in accordance with examples as disclosed herein. In some examples, aspects of the operations of 1710 may be performed by a reference signal reception component 930 as described with reference to FIG. 9.

At 1715, the method may include performing a measurement procedure of a reference signal from a set of a plurality of cells that include the cell. The operations of 1715 may be performed in accordance with examples as disclosed herein. In some examples, aspects of the operations of 1715 may be performed by a measurement component 960 as described with reference to FIG. 9.

At 1720, the method may include transmitting a second message indicating the cell based at least in part on the indicated cell having a highest signal strength among the plurality of cells. The operations of 1720 may be performed in accordance with examples as disclosed herein. In some examples, aspects of the operations of 1720 may be performed by a measurement component 960 as described with reference to FIG. 9.

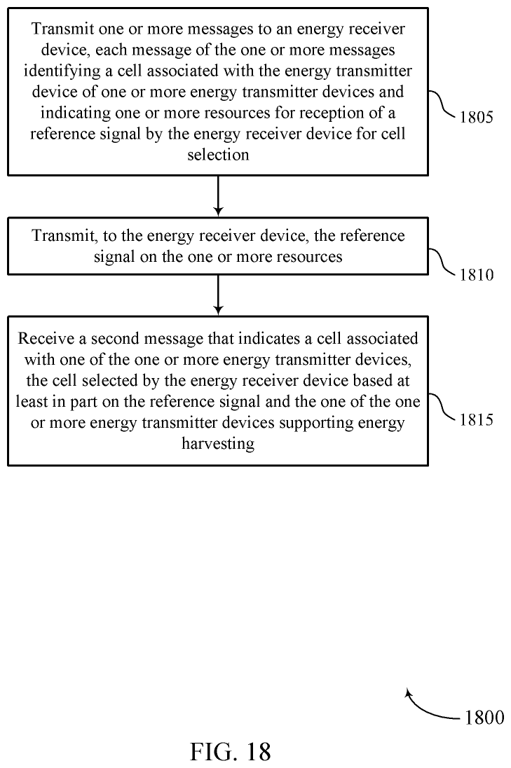

FIG. 18 shows a flowchart illustrating a method 1800 that supports cell selection of a passive device in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting one or more messages to an energy receiver device, each message of the one or more messages identifying a cell associated with the energy transmitter device of one or more energy transmitter devices and indicating one or more resources for reception of a reference signal by the energy receiver device for cell selection. The operations of 1805 may be performed in accordance with examples as disclosed herein. In some examples, aspects of the operations of 1805 may be performed by a message transmission component 1325 as described with reference to FIG. 13.

At 1810, the method may include transmitting, to the energy receiver device, the reference signal on the one or more resources. The operations of 1810 may be performed in accordance with examples as disclosed herein. In some examples, aspects of the operations of 1810 may be performed by a reference signal transmission component 1330 as described with reference to FIG. 13.

At 1815, the method may include receiving a second message that indicates a cell associated with one of the one or more energy transmitter devices, the cell selected by the energy receiver device based at least in part on the reference signal and the one of the one or more energy transmitter devices supporting energy harvesting. The operations of 1815 may be performed in accordance with examples as disclosed herein. In some examples, aspects of the operations of 1815 may be performed by a cell message component 1335 as described with reference to FIG. 13.

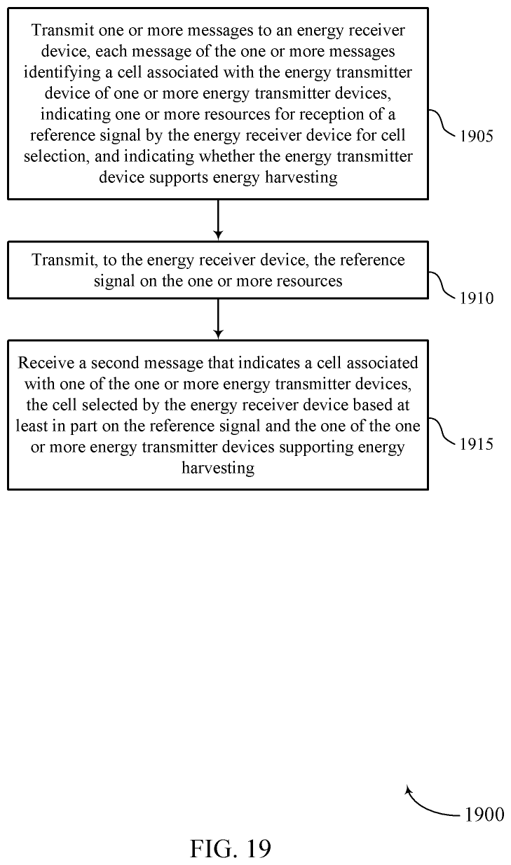

FIG. 19 shows a flowchart illustrating a method 1900 that supports cell selection of a passive device in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting one or more messages to an energy receiver device, each message of the one or more messages identifying a cell associated with the energy transmitter device of one or more energy transmitter devices, indicating one or more resources for reception of a reference signal by the energy receiver device for cell selection, and indicating whether the energy transmitter device supports energy harvesting. The operations of 1905 may be performed in accordance with examples as disclosed herein. In some examples, aspects of the operations of 1905 may be performed by a message transmission component 1325 and an energy harvesting component 1340 as described with reference to FIG. 13.

At 1910, the method may include transmitting, to the energy receiver device, the reference signal on the one or more resources. The operations of 1910 may be performed in accordance with examples as disclosed herein. In some examples, aspects of the operations of 1910 may be performed by a reference signal transmission component 1330 as described with reference to FIG. 13.

At 1915, the method may include receiving a second message that indicates a cell associated with one of the one or more energy transmitter devices, the cell selected by the energy receiver device based at least in part on the reference signal and the one of the one or more energy transmitter devices supporting energy harvesting. The operations of 1915 may be performed in accordance with examples as disclosed herein. In some examples, aspects of the operations of 1915 may be performed by a cell message component 1335 as described with reference to FIG. 13.

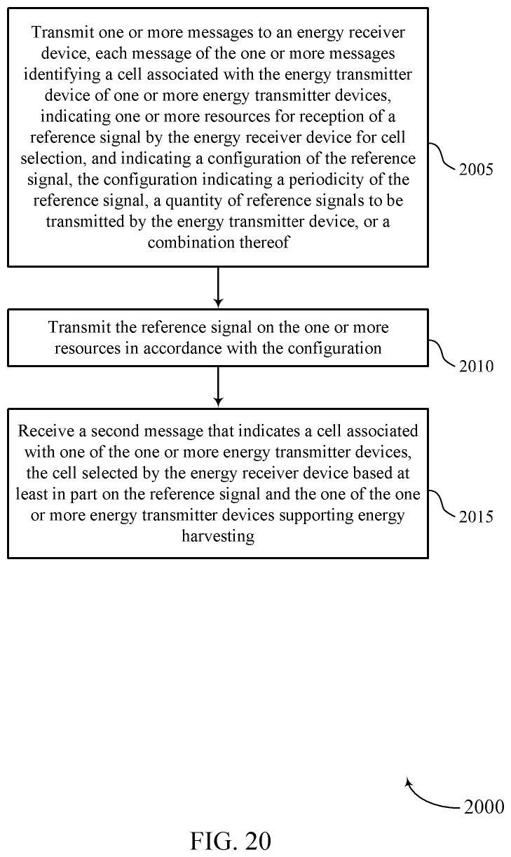

FIG. 20 shows a flowchart illustrating a method 2000 that supports cell selection of a passive device in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting one or more messages to an energy receiver device, each message of the one or more messages identifying a cell associated with the energy transmitter device of one or more energy transmitter devices, indicating one or more resources for reception of a reference signal by the energy receiver device for cell selection, and indicating a configuration of the reference signal, the configuration indicating a periodicity of the reference signal, a quantity of reference signals to be transmitted by the energy transmitter device, or a combination thereof. The operations of 2005 may be performed in accordance with examples as disclosed herein. In some examples, aspects of the operations of 2005 may be performed by a message transmission component 1325 as described with reference to FIG. 13.

At 2010, the method may include transmitting the reference signal on the one or more resources in accordance with the configuration. The operations of 2010 may be performed in accordance with examples as disclosed herein. In some examples, aspects of the operations of 2010 may be performed by a reference signal component 1345 as described with reference to FIG. 13.

At 2015, the method may include receiving a second message that indicates a cell associated with one of the one or more energy transmitter devices, the cell selected by the energy receiver device based at least in part on the reference signal and the one of the one or more energy transmitter devices supporting energy harvesting. The operations of 2015 may be performed in accordance with examples as disclosed herein. In some examples, aspects of the operations of 2015 may be performed by a cell message component 1335 as described with reference to FIG. 13.

The following provides an overview of aspects of the present disclosure:

Aspect 1: A method for wireless communication at an energy receiver device, comprising: receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection; receiving, from the one or more energy transmitter devices, the reference signal on the one or more resources; and transmitting a second message that indicates a cell associated with one of the one or more energy transmitter devices, the cell selected by the energy receiver device based at least in part on the reference signal and the one of the one or more energy transmitter devices supporting energy harvesting.

Aspect 2: The method of aspect 1, wherein receiving the one or more messages comprises: receiving the one or more messages from the respective one or more energy transmitter devices, each message of the one or more messages indicating whether the energy transmitter device supports energy harvesting.

Aspect 3: The method of any of aspects 1 through 2, further comprising: identifying the cell associated with the energy transmitter device based at least in part on an orthogonal sequence of the one or more messages, wherein each of the one or more energy transmitter devices is associated with one of a set of orthogonal sequences that include the orthogonal sequence.

Aspect 4: The method of any of aspects 1 through 3, further comprising: identifying the cell associated with the energy transmitter device based at least in part on a resource associated with the one or more messages, wherein each of the one or more energy transmitter devices is associated with one of a set of resources that include the resource, and the resource comprises a frequency resource, a time resource, or a combination thereof.

Aspect 5: The method of claim 1, further comprising: identifying a cell identifier for the cell based at least in part on a mapping between a set of cell identifiers and a corresponding set of resources used for the one or more messages, wherein the set of resources comprise frequency resources, time resources, or a combination thereof.

Aspect 6: The method of any of aspects 1 through 5, wherein receiving the one or more messages comprises: receiving the one or more messages from the respective one or more energy transmitter devices, each message of the one or more messages indicating at least one type of energy receiver device supported by the energy transmitter device transmitting the message.

Aspect 7: The method of any of aspects 1 through 6, wherein receiving the one or more messages comprises: receiving the one or more messages from the respective one or more energy transmitter devices, each message of the one or more messages indicating a configuration of the reference signal, the configuration indicating a periodicity of the reference signal, a quantity of reference signals to be transmitted by the energy transmitter device, or a combination thereof; receiving the reference signal on the one or more resources in accordance with the configuration; and selecting the cell based at least in part on the configuration and the periodicity of the reference signal.

Aspect 8: The method of any of aspects 1 through 7, wherein receiving the one or more messages comprises: receiving the one or more messages from the respective one or more energy transmitter devices, each message of the one or more messages indicating a maximum repetition associated with the second message.

Aspect 9: The method of any of aspects 1 through 8, further comprising: decoding the one or more messages received from the respective one or more energy transmitter devices; and transmitting the second message based at least in part on successfully decoding the one or more messages.

Aspect 10: The method of any of aspects 1 through 9, further comprising: transmitting the second message based at least in part on a signal strength value of a measurement of the reference signal exceeding a threshold.

Aspect 11: The method of any of aspects 1 through 10, further comprising: performing a measurement procedure of a reference signal from a plurality of cells that include the cell; and transmitting the second message indicating the cell based at least in part on the indicated cell having a highest signal strength among the plurality of cells.

Aspect 12: The method of any of aspects 1 through 11, further comprising: generating a metric for each cell associated with the one or more energy transmitter devices based at least in part on an average measured RSRP for one or more reference signals received in a time period, a highest measured RSRP of a reference signal in a time window, an average measured RSRP of one or more highest measured RSRPs for one or more reference signals, or an averaged measured RSRP of one or more RSRPs above a threshold for one or more reference signals; and selecting the cell based at least in part on the metric.

Aspect 13: The method of any of aspects 1 through 12, wherein transmitting the second message comprises: transmitting the second message that indicates a PCI associated with the cell selected by the energy receiver device, wherein each message of the one or more messages indicates a PCI.

Aspect 14: A method for wireless communication at an energy transmitter device, comprising: transmitting one or more messages to an energy receiver device, each message of the one or more messages identifying a cell associated with the energy transmitter device of one or more energy transmitter devices and indicating one or more resources for reception of a reference signal by the energy receiver device for cell selection; transmitting, to the energy receiver device, the reference signal on the one or more resources; and receiving a second message that indicates a cell associated with one of the one or more energy transmitter devices, the cell selected by the energy receiver device based at least in part on the reference signal and the one of the one or more energy transmitter devices supporting energy harvesting.

Aspect 15: The method of aspect 14, wherein transmitting the one or more messages comprises: transmitting the one or more messages from respective one or more energy transmitter devices, each message of the one or more messages indicating whether the energy transmitter device supports energy harvesting.

Aspect 16: The method of any of aspects 14 through 15, wherein each of the one or more energy transmitter devices is associated with one of a set of orthogonal sequences.

Aspect 17: The method of any of aspects 14 through 16, wherein each of the one or more energy transmitter devices is associated with resources of a set of resources that include the one or more resources, and the one or more resources comprises a frequency resource, a time resource, or a combination thereof.

Aspect 18: The method of any of aspects 14 through 17, wherein each message of the one or more messages identifies the cell based at least in part on a mapping between a set of cell identifiers and a corresponding set of resources used for the one or more messages, wherein the set of resources comprise frequency resources, time resources, or a combination thereof.

Aspect 19: The method of any of aspects 14 through 18, wherein transmitting the one or more messages comprises: transmitting the one or more messages from respective one or more energy transmitter devices, each message of the one or more messages indicating at least one type of energy receiver device supported by the energy transmitter device transmitting the message.

Aspect 20: The method of any of aspects 14 through 19, wherein transmitting the one or more messages comprises: transmitting the one or more messages from respective one or more energy transmitter devices, each message of the one or more messages indicating a configuration of the reference signal, the configuration indicating a periodicity of the reference signal, a quantity of reference signals to be transmitted by the energy transmitter device, or a combination thereof; and transmitting the reference signal on the one or more resources in accordance with the configuration.

Aspect 21: The method of any of aspects 14 through 20, wherein transmitting the one or more messages comprises: transmitting the one or more messages from respective one or more energy transmitter devices, each message of the one or more messages indicating a maximum repetition associated with the second message.

Aspect 22: The method of any of aspects 14 through 21, wherein receiving the second message comprises: receiving the second message based at least in part on the energy receiver device successfully decoding the one or more messages.

Aspect 23: The method of any of aspects 14 through 22, wherein receiving the second message comprises: receiving the second message based at least in part on a signal strength value of a measurement of the reference signal exceeding a threshold.

Aspect 24: The method of any of aspects 14 through 23, wherein receiving the second message comprises: receiving the second message indicating the cell selected by the energy receiver device based at least in part on the cell having a highest signal strength among a plurality of cells.

Aspect 25: The method of any of aspects 14 through 24, wherein receiving the second message comprises: receiving the second message that indicates a PCI associated with the cell selected by the energy receiver device, wherein each message of the one or more messages indicates a PCI.

Aspect 26: An apparatus for wireless communication at an energy receiver device, comprising at least one processor; and memory coupled with the at least one processor, the memory storing instructions executable by the at least one processor to cause the energy receiver device to perform a method of any of aspects 1 through 13.

Aspect 27: An apparatus for wireless communication at an energy receiver device, comprising at least one means for performing a method of any of aspects 1 through 13.

Aspect 28: A non-transitory computer-readable medium storing code for wireless communication at an energy receiver device, the code comprising instructions executable by at least one processor to perform a method of any of aspects 1 through 13.

Aspect 29: An apparatus for wireless communication at an energy transmitter device, comprising at least one processor; and memory coupled with the at least one processor, the memory storing instructions executable by the at least one processor to cause the energy transmitter device to perform a method of any of aspects 14 through 25.

Aspect 30: An apparatus for wireless communication at an energy transmitter device, comprising at least one means for performing a method of any of aspects 14 through 25.

Aspect 31: A non-transitory computer-readable medium storing code for wireless communication at an energy transmitter device, the code comprising instructions executable by at least one processor to perform a method of any of aspects 14 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software (e.g., executed by a processor), or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at an energy receiver device, comprising:
receiving one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection;
receiving, from the one or more energy transmitter devices, the reference signal on the one or more resources; and
transmitting a second message that indicates a cell associated with one of the one or more energy transmitter devices, the cell selected by the energy receiver device based at least in part on the reference signal and the one of the one or more energy transmitter devices supporting energy harvesting.

2. The method of claim 1, wherein receiving the one or more messages comprises:
receiving the one or more messages from the respective one or more energy transmitter devices, each message of the one or more messages indicating whether the energy transmitter device supports energy harvesting.

3. The method of claim 1, further comprising:
identifying the cell associated with the energy transmitter device based at least in part on an orthogonal sequence of the one or more messages, wherein each of the one or more energy transmitter devices is associated with one of a set of orthogonal sequences that include the orthogonal sequence.

4. The method of claim 1, further comprising:
identifying the cell associated with the energy transmitter device based at least in part on a resource associated with the one or more messages, wherein each of the one or more energy transmitter devices is associated with one of a set of resources that include the resource, and the resource comprises a frequency resource, a time resource, or a combination thereof.

5. The method of claim 1, further comprising:
identifying a cell identifier for the cell based at least in part on a mapping between a set of cell identifiers and a corresponding set of resources used for the one or more messages, wherein the set of resources comprise frequency resources, time resources, or a combination thereof.

6. The method of claim 1, wherein receiving the one or more messages comprises:
receiving the one or more messages from the respective one or more energy transmitter devices, each message of the one or more messages indicating at least one type of energy receiver device supported by the energy transmitter device transmitting the message.

7. The method of claim 1, wherein receiving the one or more messages comprises:
receiving the one or more messages from the respective one or more energy transmitter devices, each message of the one or more messages indicating a configuration of the reference signal, the configuration indicating a periodicity of the reference signal, a quantity of reference signals to be transmitted by the energy transmitter device, or a combination thereof;
receiving the reference signal on the one or more resources in accordance with the configuration; and
selecting the cell based at least in part on the configuration and the periodicity of the reference signal.

8. The method of claim 1, wherein receiving the one or more messages comprises:
receiving the one or more messages from the respective one or more energy transmitter devices, each message of the one or more messages indicating a maximum repetition associated with the second message.

9. The method of claim 1, further comprising:
decoding the one or more messages received from the respective one or more energy transmitter devices; and
transmitting the second message based at least in part on successfully decoding the one or more messages.

10. The method of claim 1, further comprising:
transmitting the second message based at least in part on a signal strength value of a measurement of the reference signal exceeding a threshold.

11. The method of claim 1, further comprising:
performing a measurement procedure of a reference signal from a plurality of cells that include the cell; and
transmitting the second message indicating the cell based at least in part on the indicated cell having a highest signal strength among the plurality of cells.

12. The method of claim 1, further comprising:
generating a metric for each cell associated with the one or more energy transmitter devices based at least in part on an average measured reference signal received power for one or more reference signals received in a time period, a highest measured reference signal received power of a reference signal in a time window, an average measured reference signal received power of one or more highest measured reference signal received powers for one or more reference signals, or an averaged measured reference signal received power of one or more reference signal received powers above a threshold for one or more reference signals; and
selecting the cell based at least in part on the metric.

13. The method of claim 1, wherein transmitting the second message comprises:
transmitting the second message that indicates a physical cell identifier associated with the cell selected by the energy receiver device, wherein each message of the one or more messages indicates a physical cell identifier.

14. A method for wireless communication at an energy transmitter device, comprising:
transmitting one or more messages to an energy receiver device, each message of the one or more messages identifying a cell associated with the energy transmitter device of one or more energy transmitter devices and indicating one or more resources for reception of a reference signal by the energy receiver device for cell selection;
transmitting, to the energy receiver device, the reference signal on the one or more resources; and
receiving a second message that indicates a cell associated with one of the one or more energy transmitter devices, the cell selected by the energy receiver device based at least in part on the reference signal and the one of the one or more energy transmitter devices supporting energy harvesting.

15. The method of claim 14, wherein transmitting the one or more messages comprises:
transmitting the one or more messages from respective one or more energy transmitter devices, each message of the one or more messages indicating whether the energy transmitter device supports energy harvesting.

16. The method of claim 14, wherein each of the one or more energy transmitter devices is associated with one of a set of orthogonal sequences.

17. The method of claim 14, wherein each of the one or more energy transmitter devices is associated with resources of a set of resources that include the one or more resources, and the one or more resources comprises a frequency resource, a time resource, or a combination thereof.

18. The method of claim 14, wherein each message of the one or more messages identifies the cell based at least in part on a mapping between a set of cell identifiers and a corresponding set of resources used for the one or more messages, wherein the set of resources comprise frequency resources, time resources, or a combination thereof.

19. The method of claim 14, wherein transmitting the one or more messages comprises:
transmitting the one or more messages from respective one or more energy transmitter devices, each message of the one or more messages indicating at least one type of energy receiver device supported by the energy transmitter device transmitting the message.

20. The method of claim 14, wherein transmitting the one or more messages comprises:
transmitting the one or more messages from respective one or more energy transmitter devices, each message of the one or more messages indicating a configuration of the reference signal, the configuration indicating a periodicity of the reference signal, a quantity of reference signals to be transmitted by the energy transmitter device, or a combination thereof; and
transmitting the reference signal on the one or more resources in accordance with the configuration.

21. The method of claim 14, wherein transmitting the one or more messages comprises:
transmitting the one or more messages from respective one or more energy transmitter devices, each message of the one or more messages indicating a maximum repetition associated with the second message.

22. The method of claim 14, wherein receiving the second message comprises:
receiving the second message based at least in part on the energy receiver device successfully decoding the one or more messages.

23. The method of claim 14, wherein receiving the second message comprises:
receiving the second message based at least in part on a signal strength value of a measurement of the reference signal exceeding a threshold.

24. The method of claim 14, wherein receiving the second message comprises:
receiving the second message indicating the cell selected by the energy receiver device based at least in part on the cell having a highest signal strength among a plurality of cells.

25. The method of claim 14, wherein receiving the second message comprises:
receiving the second message that indicates a physical cell identifier associated with the cell selected by the energy receiver device, wherein each message of the one or more messages indicates a physical cell identifier.

26. An apparatus for wireless communication at an energy receiver device, comprising:
at least one processor; and
memory coupled with the at least one processor, the memory storing instructions executable by the at least one processor to cause the energy receiver device to:
receive one or more messages from respective one or more energy transmitter devices, each message of the one or more messages identifying a cell associated with an energy transmitter device of the one or more energy transmitter devices and indicating one or more resources for reception of a reference signal from the energy transmitter device for cell selection;
receive, from the one or more energy transmitter devices, the reference signal on the one or more resources; and
transmit a second message that indicates a cell associated with one of the one or more energy transmitter devices, the cell selected by the energy receiver device based at least in part on the reference signal and the one of the one or more energy transmitter devices supporting energy harvesting.

27. The apparatus of claim 26, wherein the instructions to receive the one or more messages are executable by the at least one processor to cause the energy receiver device to:
receive the one or more messages from the respective one or more energy transmitter devices, each message of the one or more messages indicating whether the energy transmitter device supports energy harvesting.

28. The apparatus of claim 26, wherein the instructions are further executable by the at least one processor to cause the energy receiver device to:
identify the cell associated with the energy transmitter device based at least in part on an orthogonal sequence of the one or more messages, wherein each of the one or more energy transmitter devices is associated with one of a set of orthogonal sequences that include the orthogonal sequence.

29. An apparatus for wireless communication at an energy transmitter device, comprising:
at least one processor; and
memory coupled with the at least one processor, the memory storing instructions executable by the at least one processor to cause the energy transmitter device to:
transmit one or more messages to an energy receiver device, each message of the one or more messages identifying a cell associated with the energy transmitter device of one or more energy transmitter devices and indicating one or more resources for reception of a reference signal by the energy receiver device for cell selection;
transmit, to the energy receiver device, the reference signal on the one or more resources; and
receive a second message that indicates a cell associated with one of the one or more energy transmitter devices, the cell selected by the energy receiver device based at least in part on the reference signal and the one of the one or more energy transmitter devices supporting energy harvesting.

30. The apparatus of claim 29, wherein the instructions to transmit the one or more messages are executable by the at least one processor to cause the energy transmitter device to:
transmit the one or more messages from respective one or more energy transmitter devices, each message of the one or more messages indicating whether the energy transmitter device supports energy harvesting.
